(19) United States
(12) Patent Application Publication
(10) Pub. No.: US 2016/0175964 A1
(43) Pub. Date: Jun. 23, 2016

(54) WELDING VISION AND CONTROL SYSTEM

(71) Applicant: LINCOLN GLOBAL, INC., Cleveland, OH (US)

(72) Inventors: Jeffrey T. Penoyer, Fort Collins, CO (US); Tyler M. Kron, Greeley, CO (US); Mike J. Davis, Longmont, CO (US); Lance Guymon, Fort Collins, CO (US); Michael S. Martin, Loveland, CO (US)

(21) Appl. No.: 14/975,696

(22) Filed: Dec. 18, 2015

Related U.S. Application Data
(60) Provisional application No. 62/094,393, filed on Dec. 19, 2014.

(51) Int. Cl. B23K 9/095; B23K 9/133; B23K 9/12; B23K 9/10

(52) U.S. Cl. CPC B23K 9/0956; B23K 9/0953; B23K 9/1062; B23K 9/133; B23K 9/126

(57) ABSTRACT

A welding vision and control system generates composite images that can image bright features as well as darker features in a welding region of a welding process in a single composite image or in a video stream of composite images for use in manual as well as automated control of the welding system. A plurality of raw images are generated from exposure time periods that occur during specific phases of a cyclical power waveform that powers the welding system. The exposure time periods can be triggered by detection of threshold levels of an electrical characteristic in the cyclical power waveform or by time delays. Certain features in the weld occur during specific phases of the cyclical power waveform, and such features can be isolated and viewed in video displays in real time by creating the exposure time periods during those specific phases. The composite images are generated by selection of individual non-saturated and non-dark pixels from a plurality of the raw images obtained during different exposure time period durations, different phases of the cyclical power waveform, different camera sensitivity and aperture settings, or a combination of those parameters.

### BACKGROUND

Welding in general is a fabrication process that joins pieces of materials, for example, metals, together in a permanent manner by causing fusion of the materials. Such fusion of adjacent pieces of metal requires enough energy to melt the metal. Arc welding is a typical welding method in which the energy necessary to melt the metal is provided by a high voltage electric arc between at least one of the metal pieces and a metal electrode that slowly melts away at the point where the electric arc emanates from the electrode to create a puddle of electrode metal which fuses together with the adjacent metal pieces. When the metals in the fused puddle and adjacent metal pieces cool, the fused metals solidify to create a welded joint that permanently joins the two metal pieces together. Welding systems and techniques have continued to improve over the years. For example, gas tungsten arc welding (TIG) uses a non-consumable tungsten electrode to produce the weld. Also, gas metal arc welding (MIG) uses a wire feeding gun that feeds an electrode wire at an adjustable rate into the welding zone, and some such welding processes reciprocate the electrode wire toward and away from the melt puddle as drops of the melted electrode wire form at the arcing distal end of the electrode wire. Some kinds of limited automated welding systems have also been developed, which have reduced the necessity for manual welding in many industrial welding environments. Improvements in power supplies in MIG and TIG welding systems have also resulted in welders that are easy to use and produce high quality welds.

The electric arcs that create the heat necessary to melt the metals in arc welding also create very intense, high energy radiation emissions, e.g., extremely bright visible light, ultraviolet, and infrared radiation. Such radiation is so intense that a person cannot look at an ongoing arc welding process without a very high risk of flash burns in which high intensity ultraviolet radiation causes inflammation of the cornea and can burn the retina of the person's eyes. Therefore, goggles or welding helmets with dark, ultraviolet filtering face plates have to be worn by welders to prevent these kinds of eye damage. Such face plates are so dark, that a person cannot see normal visible light through them, so welders have to remove the helmets in order to see when not welding, but must be sure they are in place to protect the eyes before the welding arc is struck to start a weld. More recently, face plates that darken instantly upon exposure to intense ultraviolet light have been developed for welder's helmets.

### SUMMARY

A welding vision and control system for an arc welding system in which the arc welding system is powered by a cyclical power waveform from a welding power supply to produce a weld bead on a work piece in a welding region, comprising: (i) a camera that has a light sensor array focused on the welding region or on a feature in the welding region, said camera being responsive to exposure initiating control signals to expose the light sensor array to light energy emanating or reflecting from the welding region or from a feature in the welding region to produce a series of raw images of the welding region or the feature in the welding region; and (ii) a vision system controller that generates the exposure initiating control signals to the camera at a predetermined trigger point on the cyclical power waveform. In one embodiment, the vision system controller senses when an electrical characteristic in the cyclical power waveform matches an exposure initiating threshold value and, in response, generates the exposure initiating control signals to the camera. In another embodiment, the welding power supply provides the exposure initiating control signals to the camera to initiate the exposure at the predetermined trigger point on the cyclical power waveform. In another embodiment, the welding power supply provides a triggering signal to the vision system controller that corresponds with the predetermined trigger point on the cyclical power waveform, and, in response to the triggering signal, the vision system controller generates the exposure initiating control signals to the camera. In another embodiment, the predetermined trigger point on the cyclical power waveform is variable manually or automatically.

A method of creating a series of raw images of a welding region or of a feature in the welding region during a welding process that is powered by a cyclical power waveform in which an electrical characteristic varies cyclically comprises: (i) focusing a camera on the welding region or on the feature in the welding region; and (ii) triggering the camera to expose a light sensor array in the camera to light energy emanating or reflecting from the welding region or the feature in the welding region for a sequence of exposure time periods to create the raw images of the welding region or the feature in the welding region at predetermined phases of the cyclical power waveform.

A method of viewing a particular feature in a welding region during a welding process which is powered by a cyclical power waveform in which an electrical characteristic varies cyclically comprises: (i) focusing a camera on the welding region, wherein the camera is responsive to exposure initiating control signals for initiating exposures of a light sensor array in the camera to light energy emanating or reflecting from the feature in the welding region for a sequence of exposure time periods; (ii) generating the exposure initiating control signals to expose the light sensor array to light energy emanating or reflecting from the welding region during the time periods at a first phase of the cyclical power waveform to produce a series of composite images from the sequence of exposure time periods; (iii) streaming the series of composite images of the feature to a display device for video display of features in the welding region as the features exist during the first phase of the cyclical power waveform; and (iv) changing the exposure time periods to occur at different phases of the cyclical power waveform until the exposure time periods occur at a phase in which the particular feature exists so that the particular feature is shown in the series of composite images in the video display.

An embodiment of the present invention may therefore comprise a method of generating a video of a welding process from a series of combined images produced by a camera comprising: applying a plurality of operating parameters for a first mode of operation of a video camera to generate a plurality of sets of single images of the welding process; using a waveform, created by an arc welder that performs the welding process, to synchronize the plurality of sets of single images with the welding process by: providing first trigger pulses at a first set of locations on the waveform, responsive to the operating parameters, that are used to open a shutter of the camera so that each of the single images in any given set of the sets of single images has a corresponding image in other sets of the single images that is triggered at substantially the same location on the waveforms; producing second trigger pulses at a second set of locations on the waveform, responsive to the operating parameters, that are used to close the shutter on the camera, so that each of the single images in any given set of the sets of single images has a corresponding image in other sets of the single images that has substantially the same exposure period; creating the series of combined images from the plurality of sets of single images by combining the single images in the sets of single images to produce the combined images; generating the video of the welding process from the series of combined images; analyzing the video of the welding process to provide an analysis of the welding process; modifying the welding process in response to the analysis.

An embodiment of the present invention may further comprise a system for generating a video of a welding process comprising: a wire feed welder that welds metal welding pieces to produce a weld; a welding power supply that produces a power supply waveform that is applied to the welder; a camera, having a shutter, that is aligned to generate a plurality of sets of single images of the welding process in response; a controller that senses the power supply waveform and generates first trigger pulses at a first set of locations on the waveform that are used to open the shutter on the camera so that each of the single images in any given set of the plurality of sets of single images has corresponding images in the plurality of sets of single images that are triggered at substantially a same location on the waveform, and generates second trigger pulses at a second set of locations on the waveform that are used to close the shutter on the camera so that each of the single images in any given set of the plurality of sets of single images has corresponding images in the plurality of sets of single images that have substantially equal exposure periods that start at the substantially same location on the waveform, the controller performing logical operations to combine single images in each set of single images to produce combined images that are suitable for display and analysis.

### BRIEF DESCRIPTION OF THE DRAWINGS

FIG. 1 is a schematic block diagram of an example embodiment of a welding vision and control system;

FIG. 1A is an enlarged perspective view of the welding region of a welding system;

FIG. 2 is a diagrammatic view of an example progressive exposure technique using a single threshold trigger point;

FIG. 3 is a diagrammatic view of an example progressive exposure technique with a trigger point delayed from a threshold value;

FIG. 4 is a diagrammatic view of an example constant exposure technique that utilizes a variable trigger delay;

FIG. 5 is a diagrammatic view of an example variable exposure technique that utilizes a variable trigger delay;

FIG. 6A is a flow diagram illustrating the operation of the example welding vision and control system of FIG. 1;

FIG. 6B is a flow diagram illustrating the operation of the vision system controller;

FIG. 7 illustrates an example system for initiating exposure in a the camera;

FIG. 8 is a diagrammatic illustration of an example system that can be used to temporally align the pixel streams from each of the exposures, such as illustrated in FIGS. 2-5;

FIG. 9 is a block diagram illustration of an example embodiment of an image combiner;

FIG. 9A is a diagrammatic illustration of an example system for selecting pixels that are not saturated or dark;

FIG. 9B is a diagrammatic illustration of an example bright range pixel selection system;

FIG. 9C is a diagrammatic illustration of an example dark range pixel selection system;

FIG. 10 is a diagrammatic view of an example raw image amalgamation to create a composite image;

FIG. 11 is a diagrammatic view of an example temporal pixel alignment system;

FIG. 12A is a diagram illustrating an example DC shaped power waveform and example welding phenomena that corresponds with phase of the power waveform;

FIGS. 12B, 12C, and 12D are diagrams that illustrate an example phase-based imaging system; and

FIG. 13 is a diagrammatic illustration of an example manual welding vision system.

### DETAILED DESCRIPTION OF EXAMPLE EMBODIMENTS

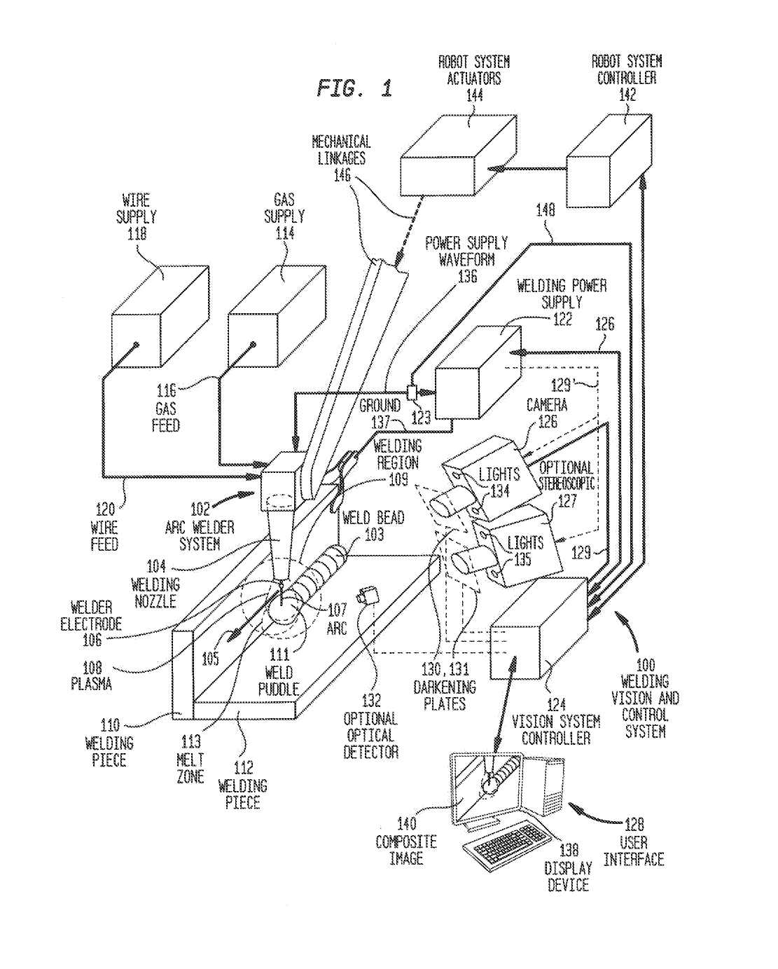

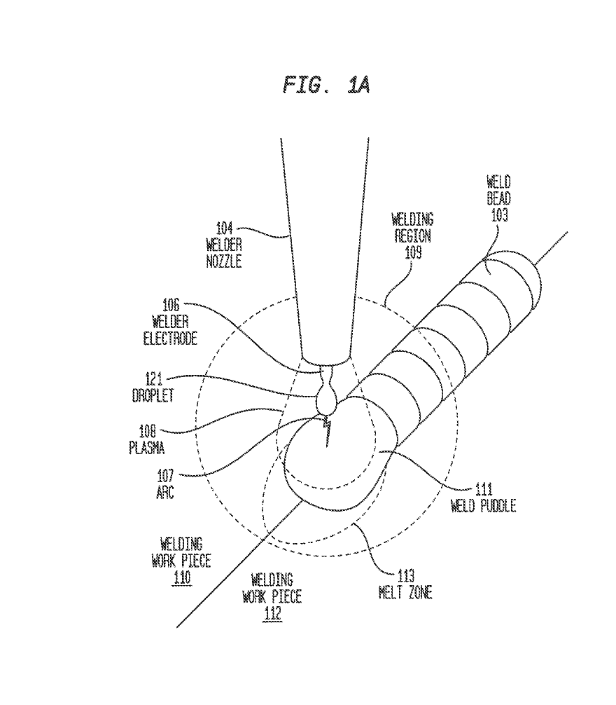

An example welding vision and control system 100 that is capable of creating, amalgamating, and displaying images, e.g., composite image 140, of a welding process and of using such images for feedback and control of the welding process is illustrated in the schematic block diagram in FIG. 1. The example welding vision and control system 100 is illustrated in FIG. 1 with an example arc welding system 102, e.g., a gas metal arc (MIG) system. However, the welding vision and control system 100 can be used with other welding systems as well, e.g., manual metal arc welding (also commonly known as stick welding), flux-cored arc welding, submerged arc welding, gas tungsten (TIG) welding, reciprocating wire, cold metal transfer (CMT), and others. In the example MIG arc welding system 102, a metal wire electrode 106 is fed by a wire feed mechanism 120 from a wire supply 118 through a tip (not visible) inside a welder nozzle 104 into a welding region 109, where two pieces of metal, e.g., metal work pieces 110, 112, are being welded together. A welding power supply 122 creates a waveform 136, which is connected electrically to the wire electrode 106. The metal work pieces 110, 112 are grounded electrically to the welding power supply 122, so a voltage provided by the power supply 122 creates an electric arc 107 between the wire electrode 106 and the metal work pieces 110, 112. The arc 107 creates a plasma 108, which is very electrically conductive, between the wire electrode 106 and the metal work pieces 110, 112. Continued application of the voltage sustains a large current flow through the plasma 108 between the distal end of the wire electrode 106 and work pieces 110, 112, which creates enough heat to melt the metal at the distal end of the wire electrode 106 as well as some metal in the work pieces 110, 112 where the current flow is concentrated in juxtaposition to the wire electrode 106, thereby creating a melt zone 113 in the work pieces 110, 112. Droplets 121 (FIG. 1A) of melted metal from the distal end of the wire electrode 106 form a metal puddle 111, which fuses with the melted metal in a melt zone 113 of the work pieces 110, 112, while a gas feed 116 directs an inert or semi-inert shielding gas flow from a gas supply 114 through the welder nozzle 104 to protect the weld site from contamination. As the welder nozzle 104 and wire electrode 106 move in the direction of the arrow 105, the metals left behind in the weld puddle 111 and melt zone 113 cool and solidify to form a solid metal weld bead 103 that permanently joins the two work pieces 110, 112 together.

The arc 107 and current flow through the plasma 108 in the example MIG welding system 102, like other arc welding systems, creates high intensity electromagnetic radiation, e.g., extremely bright visible light, ultraviolet, and infrared radiation. Such radiation is so intense that a person cannot look at the welding region 109 of an ongoing arc welding process without a very high risk of damage to the person's eyes, e.g., flash burns in which high intensity ultraviolet radiation causes inflammation of the cornea and can burn the retina. Therefore, welding goggles or helmets (not shown in FIG. 1) with dark, ultraviolet filtering face plates have to be worn by welders to prevent eye damage. Such face plates are so dark that a person cannot see normal visible light through them. Consequently, welders have to remove the helmets when not welding in order to see, but must be sure the helmets are in place to protect the eyes before the welding arc is struck to start a weld in order to attenuate the most intense visible light and ultraviolet radiation to lower intensity levels acceptable for a person's eyes. The person can see the remaining light from the brightest portions and features of an ongoing welding process that still passes through the dark goggles or face plates, e.g., the arc 107 and plasma 108, but other features, such as the cooling weld bead 103, outer reaches of the melt zone 113, and adjacent portions of the metal work pieces 110, 112 in the welding region 109, which do not emanate or reflect such intense radiation, are not visible at all through such dark goggles or face plates. Therefore, the ability of a person to see and evaluate all of the features and processes in the welding region 109 in real time for guidance of the weld process, evaluation, or quality control is limited. Similarly, conventional cameras do not have the dynamic range necessary to capture images of both the brightest features in a welding region 109 and darker features in the welding region 109 at the same time, especially to display such features in real time as the welding process takes place. Aperture settings that would admit enough light for a camera light sensor array or a photographic film to capture the darker features in the welding region would also admit so much of the extremely high intensity light from the brightest features that such high intensity light would saturate the parts of the film or light sensor array that are exposed to the brightest light, thereby rendering those parts of the captured image of the welding region 109 meaningless and useless, whereas aperture settings that attenuate the light enough to avoid saturation of image sensors or film by the brightest light will not enable the image sensors or film to capture the images of the darker portions of the welding region 109.

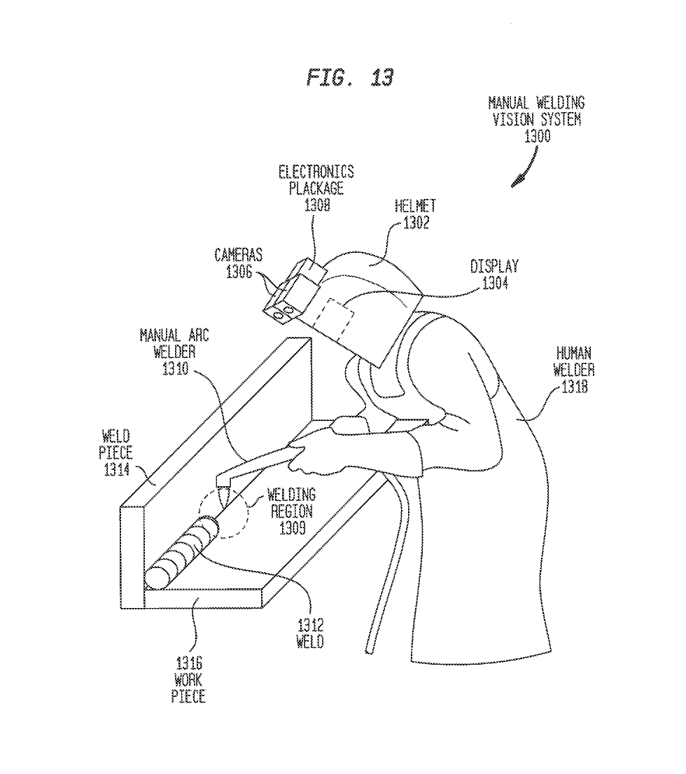

In contrast, the example welding vision and control system 100 shown in FIG. 1 and described in more detail below creates composite images that display all of the features in the welding region 109 in visible light ranges that are easily viewable by humans in real time as the welding process takes place and that can be processed and used for automatic welder controls to monitor and optimize weld quality. For example, the composite images produced by the example welding vision and control system 100 can be viewed for the purposes of monitoring and evaluating the welding process as well as for adjusting welding parameters, such as voltage and/or current of the example arc welding system 102, the location and speed of the welding nozzle 104 and tip (not visible in FIG. 1) in relation to the work pieces 110, 112, the rate of feeding the consumable wire electrode 106 into the welding region 109, the size of the welding puddle 111, and other parameters that may improve welds created by the welding system 102. The composite images can be viewed by a user who may adjust the parameters, or the composite images can be processed with machine vision and pattern recognition techniques that are capable of automatically adjusting parameters of the welding process. The composite images created can also be used in manual welding. For example, as illustrated in FIG. 13 and explained in more detail below, welding helmets used in manual welding can be equipped with a display that allows a welder to view the composite images of the welding region 109, including all of the features, e.g., welder nozzle 104, wire electrode 106, arc 107, plasma 108, weld puddle 111, melt zone 113, and adjacent portions of the work pieces 110, 112, in real time as the weld bead 103 is being formed. These capabilities are achieved by creating a broader visible spectrum, or a high dynamic range of the image, by amalgamating (combining) individual images captured electronically with various exposures, at various phases, and for various time periods during the power supply waveform 136, as explained in more detail below. The composite images can also be phased to isolate and display in real time one or more particular features in the welding region 109, e.g., a droplet 121 of molten metal formed from the consumable wire electrode 106 in one or more locations between the wire electrode 106 and the weld puddle 111 as will be described in more detail below.

With continuing reference to FIG. 1, the welding power supply 122 can be controlled to output the power waveform 136 with different electrical parameters, e.g., current, voltage, impedance, frequency, waveform shape, etc., depending on particular metals being welded, electrodes being used, weld characteristics desired, environmental influences, etc. The welding power supply 122 can be controlled independently for those and other parameters, or it can be controlled by a vision system controller 124, as indicated by the link 125 in FIG. 1. The vision system controller 124, which may comprise a programmable computer, or a series of logic circuits, such as FPGAs or state machine devices, can also receive signals from the welding power supply 122 as indicated by the control link 125, e.g., signals indicative of the power supply waveform 136 or of trigger point in the power supply waveform 136 as will be explained in more detail below. The vision system controller 124 can also get input from the power supply waveform 136, for example, from a voltage or current detector 123, as indicated by the link 148 in FIG. 1. Voltage sensors and current detectors suitable for this application are well-known and commercially available. The vision system controller 124 can also be connected to a robot system controller 142, which generates control signals to robot system actuators 144 that move and position the welder nozzle 104 and electrode 106 in relation to the work pieces 110, 112. Appropriate mechanical linkages 146 are provided to connect the robot system actuators 144 to the welder nozzle 104, electrode 106, and other components of the arc welding system 102 as is understood by persons skilled in the art, so further descriptions of such linkages 146 and actuators 144 is not necessary for an understanding of the invention. A user interface 128 is connected to the vision system controller 124 for inputting control signals to the vision system controller 124 for configuring the welding power supply 122 to provide a desired waveform 136 and for configuring the robot system controller 142 for desired inputs to the robot system actuators 144. The connection can be a hard wired connection or a wireless connection. The robot system controller 142 can be a separate unit or part of the vision system controller 124.

A digital camera 126 is positioned adjacent to the arc welding system 102 where it can be focused on one or more features in the welding region 109, e.g., the arc 107 and adjacent wire electrode 106 and weld puddle 111, or on the entire welding region 109 in which some or all of such features are located. An optional second digital camera 127 can also be used for stereoscopic imaging if desired, for example as described below for the cameras 1306 the manual welding system 1300 illustrated in FIG. 13. Camera control, lighting, raw image production by the camera 126, processing techniques to create composite images from the raw images, and other information and descriptions that apply to the camera 126 also apply to the optional second camera 127. The digital camera 126 is controlled to create raw images of the features in the welding region 109, including, for example, the welder nozzle 104, the welder wire electrode 106, the arc 107, the plasma 108, the droplets 121 (FIG. 1A), the weld puddle 111, the melt zone 113, the weld bead 103, and adjacent portions of the work pieces 110, 112. In one embodiment, the digital camera 126 is controlled by signals from the vision system controller 124, as indicated by the camera control link 129 in FIG. 1, to expose the light sensor array in the digital camera 126 to light emanating or reflecting from such features in the welding region 109. In another embodiment, the digital camera is controlled by signals from the welding power supply 122, as indicated by the optional camera control link 129′ in FIG. 1, to expose the light sensor array in the digital camera 126 to light emanating or reflecting from such features in the welding region 109. As explained in more detail below, different exposures are used to generate different raw images of the weld and surrounding area, which are amalgamated (combined) together in controller 124 to create a composite image, e.g., the composite image 140, that can be viewed on a display device 138 at the user interface 128 or at any other location. The raw images show the features in the welding region 109 at different exposures. By amalgamating the images with different exposures, all or selected ones of the features in the welding region 109 can be displayed and viewed simultaneously in a high dynamic range, composite image, whereas some of the features in the welding region 109 would be too bright and others too dark for a light sensor array to capture in one simple image from one exposure. For example, because of the different light intensities emanating or reflecting from the different features in the welding region 109, one exposure may enable the light sensor array (not shown) in the camera 126 to capture a raw image of the arc 107 quite effectively, while another exposure may enable the light sensor array in the camera 126 to capture a raw image of the molten metal droplets 121 produced at the melting distal end of the wire electrode 106 more effectively. Still another exposure may enable the light sensor array of the camera 126 to capture a raw image of the weld puddle 111 and the melt zone 113, and yet another exposure may enable the image sensor of the camera 126 to capture raw images of other peripheral features such as adjacent portions of the work pieces 110, 112 and the solidified weld bead 103. By amalgamating these different raw images into an composite image, all or selected ones of the important features in the welding region 109 can be displayed in the resulting composite image, e.g., the composite image 140 in FIG. 1. Lights 134 mounted on the camera 126 (lights 135 on the optional camera 127) can help to illuminate the background or peripheral features, such as welding pieces 110, 112 and solidified weld bead 103, if desired, and may reduce the required exposure time necessary to capture such background features in a raw image.

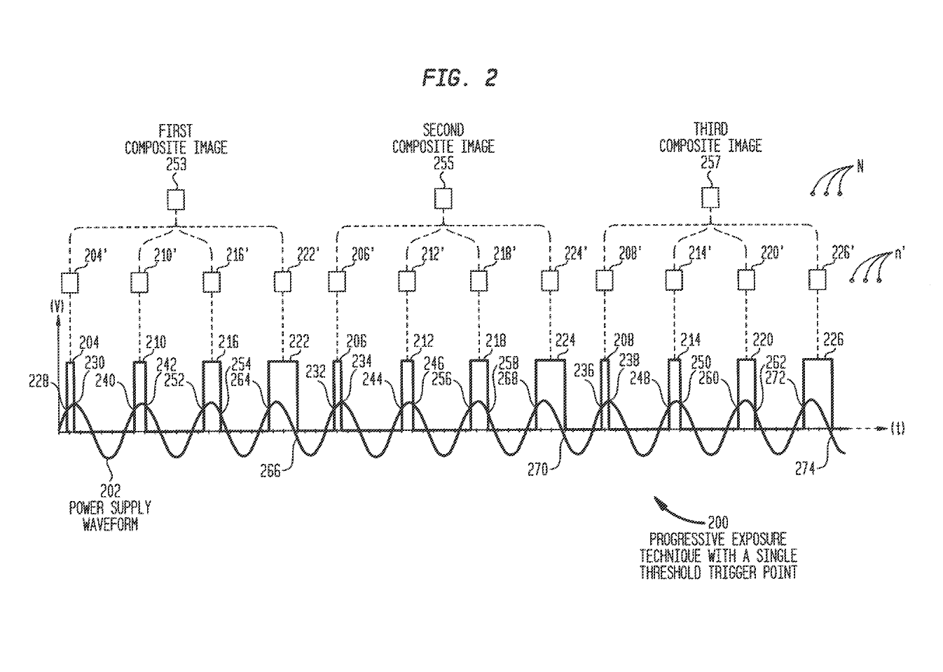

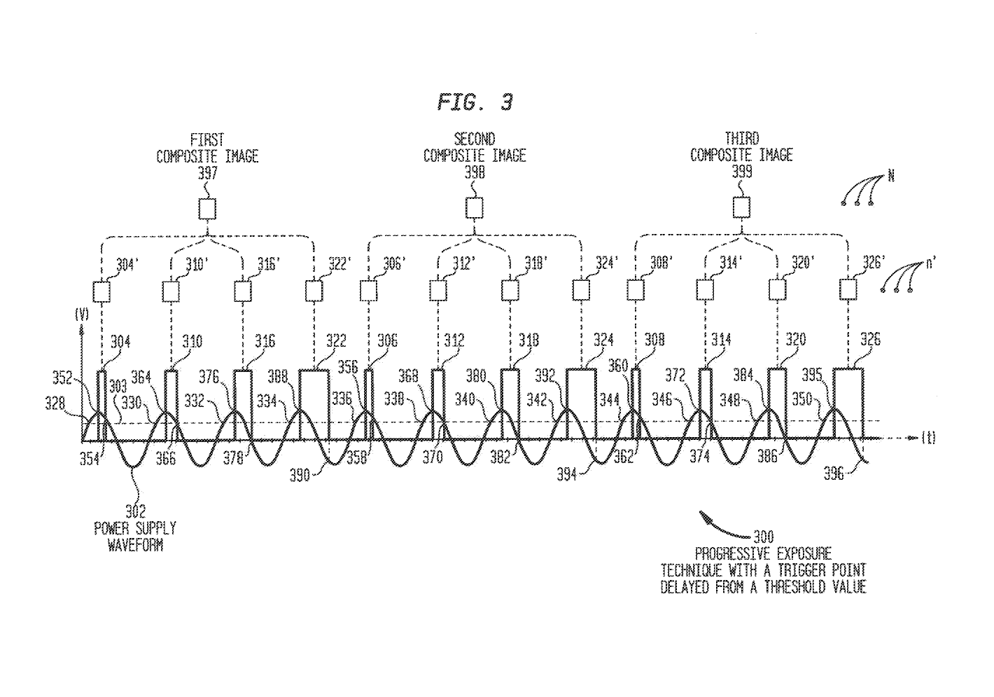

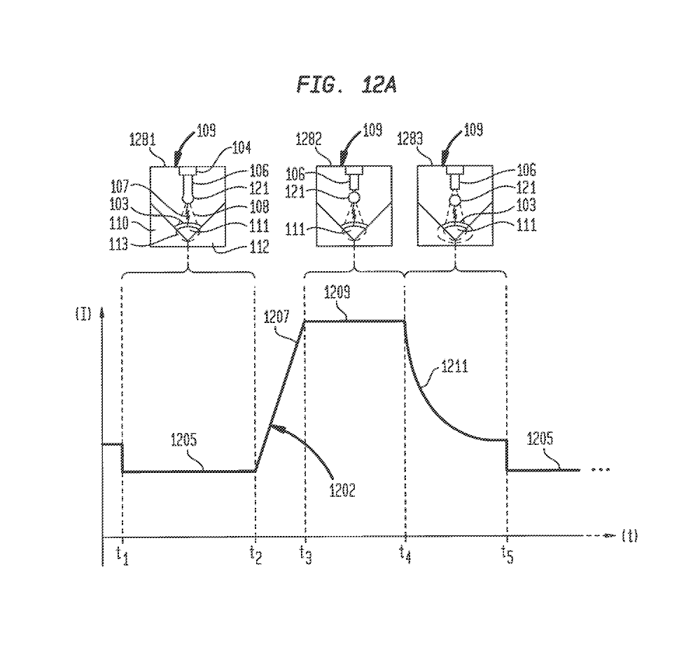

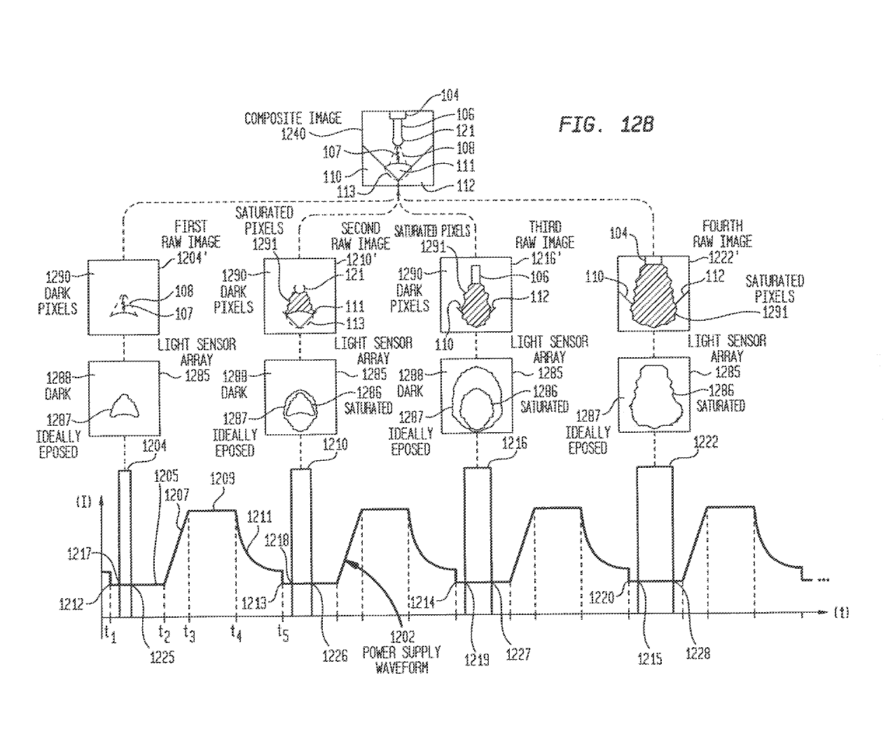

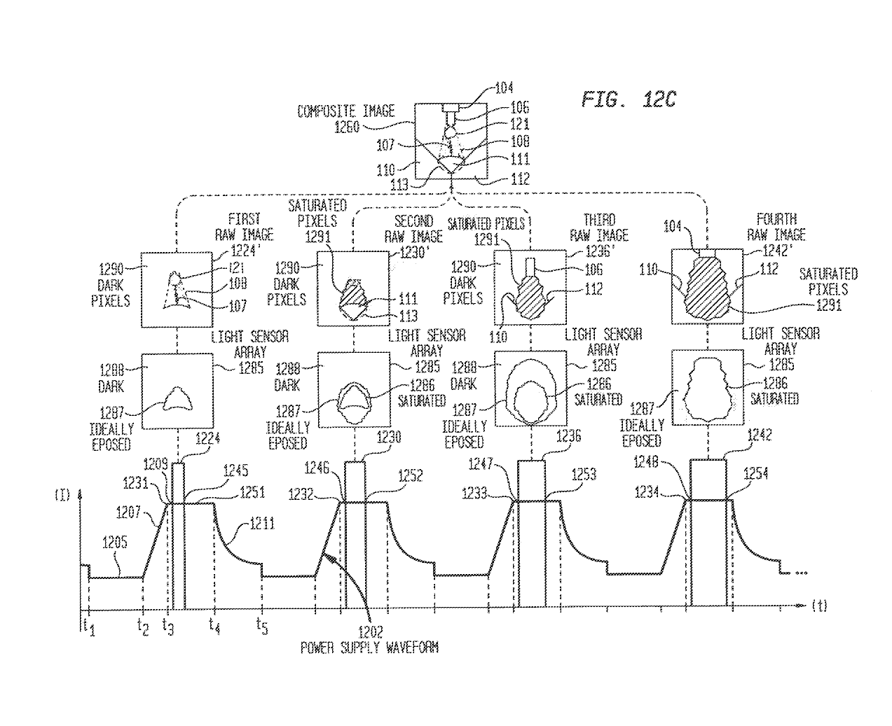

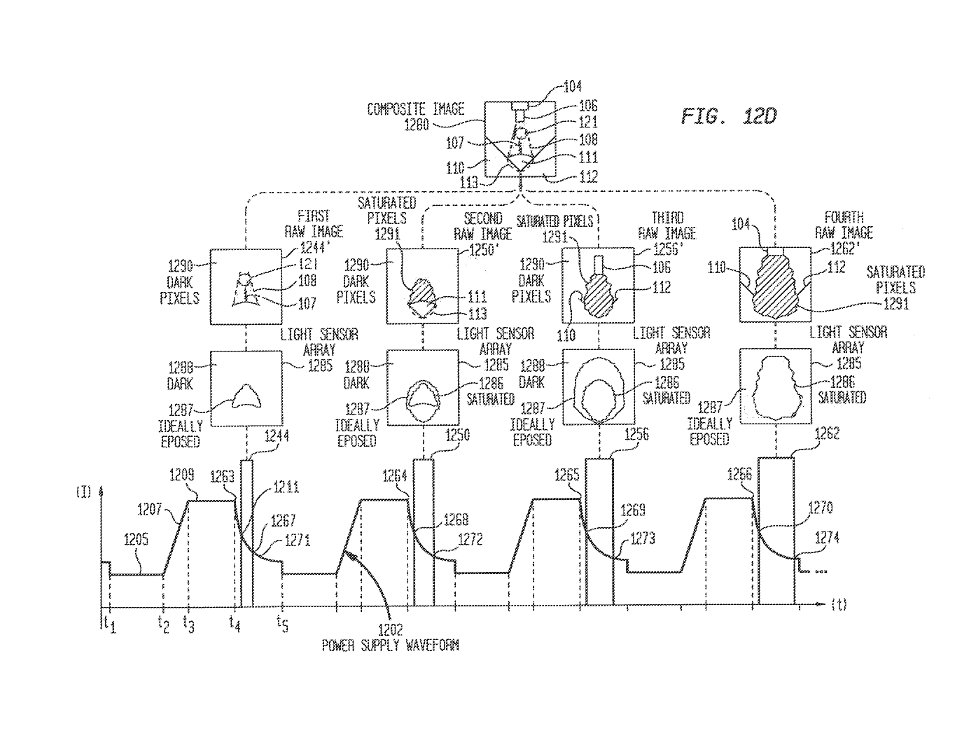

An example exposure technique 200 illustrated in FIG. 2 for exposing the light sensor array (not shown) of the camera 126 to the welding region 109 (FIG. 1). In this example exposure technique 200, a sequence of exposures of the light sensor array of the camera 126 to the light energy emanating or reflecting from the welding region 109 or particular features in the welding region 109 are triggered at respective initiating trigger points 228, 240, 252, 264, 232, 244, 256, 268, 236, 248, 260, 272 on the power supply waveform for successive exposure time periods 204, 210, 216, 222, 206, 212, 218, 208, 214, 220, 226 to produce a series of respective raw images 204′, 210′, 216′, 222′, 206′, 212′, 218′, 208′, 214′, 220′, 226′, which are used to create the composite images 253, 255, 257. As mentioned above, such composite images 253, 255, 257 can be processed for display, such as the composite image 140 shown in the display device 138 in FIG. 1, or for automated control of the example arc welding system 102 in FIG. 1. The type of the power waveform 136 (FIG. 1) illustrated in the example exposure technique 200 in FIG. 2 is a cyclical power waveform 202. The example cyclical power waveform 202 is sinusoidal, which is convenient for describing the principles of this exposure technique 200, although pulsed AC or DC power waveforms, including signals with customized or specialized rise, peak, background, and tail-out slopes and amplitudes, are commonly used in many modern welding systems, and this exposure technique 200 is applicable and usable with such pulsed power waveforms, as will be understood by persons skilled in the art once they understand the principles of this technique. One example of the application of this technique to a cyclical DC pulse power waveform is shown in FIGS. 12A, 12B, and 12C and will be described in more detail below.

In the temporal graph of the example power waveform 202 in FIG. 2, time (t) extends along the abscissa (horizontal) axis, and voltage (V) is shown in the vertical direction, i.e., ordinate. In this example exposure technique 200, a single threshold voltage level on the waveform 202 (e.g., the example voltage level at initiating trigger points 228, 240, 252, 264, 232, 244, 256, 268, 236, 248, 260, and 272) is used to initiate (trigger) exposure of the light sensor array of the camera 126 (FIG. 1) to light emanating and reflecting from the welding region 109, whereby the camera 126 acquires raw images of the welding region 109 or of particular features in the welding region 109 as explained in more detail below. Persons skilled in the art understand the technologies and implementations of electronic cameras, so an extensive explanation of details about the camera 126 (FIG. 1) are not necessary to the understanding of this exposure triggering technique. Suffice it to say that contemporary electronic cameras have a typically two-dimensional array of light sensors (typically CMOS or CCD sensors), commonly called light sensor arrays, that, when exposed to light emanating or reflected from an object (e.g., the welding region 109 or a feature in the welding region 109), convert the light energy from the object into a raw image (e.g., the raw images 204′, 210′, 216′, 222′, 206′, 212′, 218′, 208′, 214′, 220′, 226′) in a pixel array format in which each pixel in the pixel array has a pixel value of an electrical nature (e.g., voltage, current, resistance, etc.) that is indicative of the light energy that is absorbed by each light sensor in the light sensor array during the exposure. Therefore, the light sensor array produces an electronic pixel array of pixel values that represent the various light intensities that emanate or are reflected from the object. Such pixel arrays can be processed to create a visual image of the object. The exposure time of the light sensor array to the light emanating or reflecting from the object can be controlled by a mechanical shutter, which physically opens and closes an aperture for a desired period of time, or by a shutter equivalent function, for example, electronically transferring pixel cell charges or voltages to a paired shaded double. Other electronic shutter equivalent techniques may also be used to initiate and terminate exposures or of light energy absorption time periods. Therefore, while references to opening and closing a shutter to initiate and end exposure time would be understood by persons skilled in the art to also be descriptive of electronic shutter operation, a more generic description is initiating and terminating the exposure. Consequently, both of these descriptions of shutter or shutter equivalent operations are equivalent and may be used interchangeably. In FIG. 2, a plurality of example exposure time periods 204, 210, 216, 222, 206, 212, 218, 224, 208, 214, 220, and 226 are illustrated. These example exposure time periods 204, 210, 216, 222, 206, 212, 218, 224, 208, 214, 220, and 226 have respective initiating trigger points 228, 240, 252, 264, 232, 244, 256, 268, 236, 248, 260, and 272 and respective terminating trigger points at 230, 242, 254, 266, 234, 246, 268, 270, 238, 250, 262, and 274.

In one example implementation of the example exposure technique 200 in FIG. 2, the vision system controller 124, which is used to control the camera 126 in this example implementation, is connected to the welding power supply 122 (e.g., via link 125 in FIG. 1) or to a power waveform sensor 123 (e.g., via link 148 in FIG. 1) to monitor a varying electrical characteristic, e.g., voltage level or current level) in the power waveform 136 in FIG. 1, which in the FIG. 2 example is the sinusoidal power waveform 202. When a predetermined voltage or current threshold is detected in the power waveform 202, the vision system controller 124 generates an initiating control signal to the camera 126 to initiate the exposure of the light sensor array in the camera 126 to the light energy emanating or reflecting from the welding region 109 or from features in the welding region 109. Actually, the threshold may be a voltage threshold, current threshold, impedance threshold, or other parameter in the power waveform 202, but, for convenience and simplicity, the graph of FIG. 2 is a graph of voltage versus time for the power waveform 202 with the understanding that it could also be another electrical characteristic. Accordingly, as the voltage increases on the power waveform 202, it reaches initiating threshold voltage level, such as the initiating threshold voltage level illustrated at the initiating trigger points 228, 240, 252, 264, 232, 244, 256, 268, 236, 248, 260 and 272. The vision system controller detects when these initiating threshold voltage values are reached and the voltage is increasing on the power waveform 202 and, in response, generates the initiating control signal to the camera 126, as set forth above. The detection of the initiating threshold voltage level can be accomplished using a simple comparison circuit in which the detected voltage is compared to the predetermined initiating threshold voltage value in the vision system controller 124 to trigger generation of the initiating control signal when the power waveform 202 voltage is increasing. The initiating threshold voltage level can be easily set in the vision system controller 124 through the user interface 128, so that the initiating threshold voltage can be easily adjusted by the user, or it can be provided in any other convenient manner.

The exposure periods 204, 210, 216, 222, 206, 212, 218, 224, 208, 214, 220, 226 in FIG. 2 illustrate the exposure time periods during which the light sensor array in the camera 126 is exposed to the light energy emanating or reflecting from the welding region 109, which is generated by the welding process or from supplied lighting, as described in more detail below. As explained above, the camera 126 produces the respective raw images 204′, 210′, 216′, 222′, 206′, 212′, 218′, 208′, 214′, 220′, 226′ from the light energy absorbed by the light sensor array of the camera 126 during the respective exposure time periods 204, 210, 216, 222, 206, 212, 218, 224, 208, 214, 220, and 226. The first set of four raw images 204′, 210′, 216′, 222′ are amalgamated together in a manner explained in more detail below to create the first composite image 253. Similarly, the second set of four raw images 206′, 212′, 218′, 224′ are amalgamated together in the same manner to create the second composite image 255. The third set of four raw images 208′, 214′, 220′, 226′ are also amalgamated together in the same manner to create the third composite image 257. Of course, additional composite images represented symbolically by the dots N in FIG. 2 are created by the vision system controller 124 (FIG. 1) from additional raw images represented symbolically by the dots n′ in FIG. 2 as the welding process continues, so that a video of the welding process can be created from a stream of the composite images 253, 255, 257, . . . , N as the arc welding system 102 moves along the work pieces 110, 112 as indicated by the arrow 105 in FIG. 1.

As illustrated in FIG. 2, the first exposure time period 204 for the first raw image 204′, which is used in creating the first composite image 253 is the same amount of time and occurs during the same phase of the power waveform 202 as the first exposure time period 206 for the first raw image 206′, which is used in creating the second composite image 255. Likewise, the first exposure time period 208 for the first raw image 208′, which is used in creating the third composite image 257 is the same amount of time and occurs during the same phase of the power waveform 202 as both the first and second exposure time periods 204, 206. Similarly, the second exposure time periods 210, 212, 214 for the raw images 210′, 212′, 214′, which are used in creating the respective composite images 253, 255, 257, are also the same as each other and occur during the same phase of the power waveform 202 as each other. Similarly, the third exposure time periods 216, 218, 220 for the raw images 216′, 218′, 220′, which are used in creating the respective composite images 253, 255, 257, are also the same as each other and occur during the same phase of the power waveform 202 as each other. Further, the fourth exposure time periods 222, 224, 226 for the raw images 222′, 224′, 226′, which are used in creating the respective composite images 253, 255, 257, are also the same as each other and occur during the same phase of the power waveform 202 as each other.

As shown in FIG. 2, each of the exposure time periods 204, 210, 216, 222 for the respective raw images 204′, 210′, 216′, 222′ is initiated at the same threshold voltage level on the power waveform 102, i.e., at the respective initiating trigger points 228, 240, 252, 264, but they endure through a larger phase of the power waveform 202, which extends through a longer time period of the welding process. Therefore, each individual raw image 204′, 210′, 216′, 222′ used in creating the first composite image 253 has a progressively longer exposure time period 204, 210, 216, 222 to the welding region 109 (FIG. 1) or to features in the welding region 109. The same principle applies to the exposure time periods 206, 212, 218, 224 for the raw images 206′, 212′, 218′, 224′ that are used in creating the second composite image 255 and to the exposure time periods 208, 214, 220, 226 for the raw images 208′, 214′, 220′, 226′ that are used in creating the third composite image 257.

As explained above, in the example exposure technique 200 illustrated in FIG. 2, all of the exposure time periods 204, 210, 216, 222, 206, 212, 218, 224, 208, 214, 220, 226 are initiated upon detection of a predetermined initiating voltage threshold level as voltage of the power waveform 202 is rising. Upon detection of voltage in the power waveform 202 rising to the predetermined initiating voltage threshold level, the vision system controller 124 outputs an initiating trigger signal to the camera 126, in response to which the camera 126 initiates exposure of the light sensor array to the light energy emanating or reflecting from features in the welding region 109 (FIG. 1), as explained above. Therefore, the detection of such initiating voltage level at the first initiating trigger point 228 causes the vision system controller 124 to output an initiating control signal to the camera 126 to initiate the first exposure time period 204. Likewise, the detection of such initiating voltage level at the second initiating trigger point 240 causes the vision system controller 124 to output an initiating control signal to the camera 126 to initiate the second exposure time period 210; the detection of such initiating voltage level at the third initiating trigger point 252 causes the vision system controller 124 to output an initiating control signal to the camera 126 to initiate the third exposure time period 216; the detection of such initiating voltage level at the fourth initiating trigger point 264 causes the vision system controller 124 to output an initiating control signal to the camera 126 to initiate the fourth exposure time period 222; the detection of such initiating voltage level at the fifth initiating trigger point 232 causes the vision system controller 124 to output an initiating control signal to the camera 126 to initiate the fifth exposure time period 206; the detection of such initiating voltage level at the sixth initiating trigger point 244 causes the vision system controller 124 to output an initiating control signal to the camera 126 to initiate the sixth exposure time period 212; the detection of such initiating voltage level at the seventh initiating trigger point 256 causes the vision system controller 124 to output an initiating control signal to the camera 126 to initiate the seventh exposure time period 218; the detection of such initiating voltage level at the eighth initiating trigger point 268 causes the vision system controller 124 to output an initiating control signal to the camera 126 to initiate the eighth exposure time period 224; the detection of such initiating voltage level at the ninth initiating trigger point 236 causes the vision system controller 124 to output an initiating control signal to the camera 126 to initiate the ninth exposure time period 208; the detection of such initiating voltage level at the tenth initiating trigger point 248 causes the vision system controller 124 to output an initiating control signal to the camera 126 to initiate the tenth exposure time period 214; the detection of such initiating voltage level at the eleventh initiating trigger point 260 causes the vision system controller 124 to output an initiating control signal to the camera 126 to initiate the eleventh exposure time period 220; and the detection of such initiating voltage level at the twelfth initiating trigger point 272 causes the vision system controller 124 to output an initiating control signal to the camera 126 to initiate the twelfth exposure time period 226. This process continues for as long as the user wants to the imaging of the welding to continue.

The vision system controller 124 also controls the durations of the respective first through twelfth exposure time periods 204, 210, 216, 222, 206, 212, 218, 224, 208, 214, 220, 226 and beyond. Accordingly, the vision system controller 124 generates and sends to the camera 126 (FIG. 1) an exposure terminating control signal at some period of time after each exposure initiating control signal, and, in response, the camera 126 terminates the exposure of the light sensor array to the light emanating or reflecting from the welding region 109. As illustrated in FIG. 2, the vision system controller 126 is programmed to generate and send terminating control signals to the camera 126 at the respective times corresponding with the terminating trigger points 230, 242, 254, 266, 234, 246, 258, 270, 238, 250, 262, 274 on the power waveform 202 to terminate the respective exposure time periods 204, 210, 216, 222, 206, 212, 218, 224, 208, 214, 220, 226. The vision system controller 124 can be programmed to generate and send the exposure terminating control signals to the camera 126 by either: (i) Clocking the time elapsed after each exposure initiating control signal is triggered at the respective initiating trigger points 228, 240, 252, 264, 232, 244, 256, 268, 236, 248, 260, and 272, and, at a predetermined time period after each such initiating control signal is triggered, generating the exposure terminating control signal; or (ii) Determining when the voltage on the power waveform 102 matches a predetermined terminating voltage threshold and, upon detecting such a match, generating the exposure terminating control signal. Examples of such predetermined time periods and of such predetermined terminating voltage thresholds for triggering the vision system controller 124 to generate the exposure terminating control signals correspond with the terminating trigger points 230, 242, 254, 266, 234, 246, 258, 270, 238, 250, 262, 274 on the power waveform 202 in FIG. 2. Again, as explained above and shown in FIG. 2, the raw images 204′, 210′, 216′, 222′ that are used to create the first composite image 253 are different, e.g., progressively longer, thereby minimizing the likelihood that sensors in the light sensor array will be saturated in the shortest exposure time period 204 for the first raw image 204′ by the most intense light energy emanating from the brightest features, e.g., arc 107 and plasma 108, of the welding region 109 (FIG. 1), while maximizing the likelihood that sensors in the light sensor array will capture some light energy from the darker features, e.g., the weld bead 103 and work pieces 110, 112, in the welding region 109 during the longest exposure time period 222 for the raw image 222′, and also enhancing the likelihood that the second and third raw images 210′ and 216′ created with the intermediate exposure time periods 210, 216 capture good views of the features that emanate or reflect moderate intensity light energy, e.g., the electrode 106, weld puddle 111, melt zone 113. Likewise, the raw images 206′, 212′, 218′, 224′ that are used to create the second composite image 255, and the raw images 208′, 214′, 220′, 226′ that are used to create the third composite image 257, are different, e.g., progressively longer, for the same reasons. Also, while the example exposure and amalgamating technique illustrated in FIG. 2 amalgamates four raw images to create each composite image 253, 255, 257, more or fewer than four raw images could be amalgamated to create the composite images. The aperture and the sensitivity of the camera 126 can also be varied for some or all of the exposures to enhance the likelihood that different features or portions of the welding region 109 can be captured in a usable manner during each exposure time period. Also, the optional dynamic darkening plate 130 (FIG. 1) can be used, as explained in more detail below, to attenuate and vary the intensities of the light energy from the welding region 109 that reaches the camera 126 to enhance the likelihood that different features or portions of the welding regions 109 can be captured effectively by the light sensor array for one or more of the raw images that are used to create the composite images.

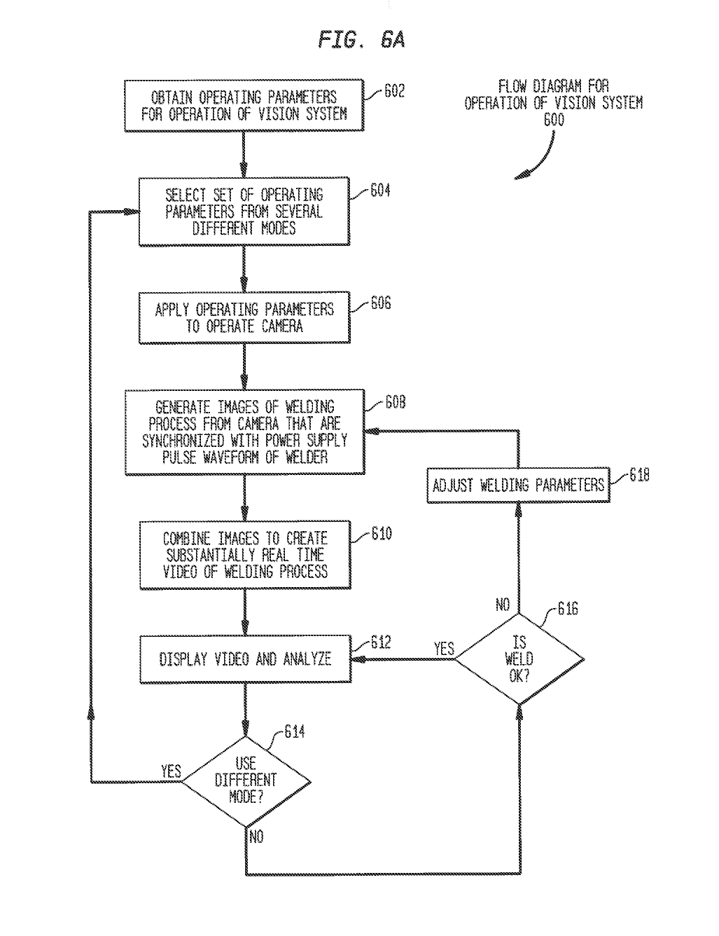

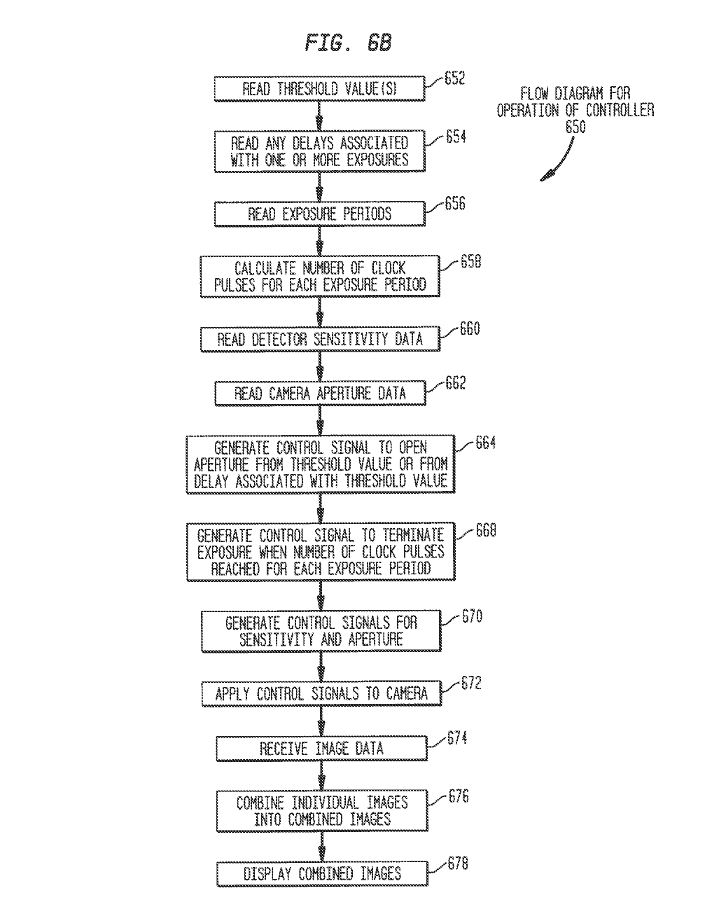

The raw images 204′, 210′, 216′, 222′ are captured by the camera 126 are fed to the vision system controller 124 are then amalgamated by the vision system controller 124 to create the first composite image 253. Similarly, the raw images 206′, 212′, 218′, 224′ captured by the camera 126 are fed to the vision system controller 124 and amalgamated to create the second composite image 255, and the raw images 208′, 214′, 220′, 226′ are amalgamated to create the third composite image 257. The composite images 253, 255, 257 are created by the vision system controller 124 in accordance with techniques described below and shown in the flow diagram of FIG. 6. The composite images 253, 255, 257 can then be displayed on the user interface 128 and stored in storage contained in the controller 124 or elsewhere for later display and analysis and for varying parameters of the arc welding system 102 to improve the quality of other characteristics of the weld. A series of the composite images 253, 255, 257, . . . , N can also be displayed in rapid sequence to provide video of the welding process in real time or for storage and subsequent viewing. The composite images 253, 255, 257 can also be used with machine vision and pattern recognition techniques for automated, real time control of the arc welding system 102 as will be explained in more detail below.

Another example progressive exposure technique 300 is illustrated in FIG. 3 with initiating trigger points 352, 364, 376, 388, 356, 368, 380, 392, 360, 372, 384, 395 that are delayed from detection of an exposure initiating threshold value 303 on the power supply waveform 302. For convenience and comparison, the example power supply waveform 302 illustrated in FIG. 3 is a sinusoidal waveform similar to the sinusoidal waveform 202 in FIG. 2, but other types of waveforms, such as pulsed AC or DC waveforms, including shaped waveforms with customized or specialized rise, peak, background, and tail-out slopes and amplitudes, as commonly used in many modern welding systems, could also be used with this technique 300. The exposure initiating threshold value 303 in the FIG. 3 example is a voltage value on the power waveform 302, but it could be a current value, impedance value, or other electrical characteristic in or associated with the power waveform 302. The exposure initiating threshold voltage 303 is detected by the vision system controller 124 at voltage threshold points 328, 330, 332, 334, 336, 338, 340, 342, 344, 346, 348, 350 on the power waveform 303. However, instead of triggering an initiating exposure control signal immediately upon detection of the initiating threshold voltage 303, the vision system controller 124 creates a delay to produce the initiating exposure control signals at a later phase on the power waveform 302, e.g., at the initiating trigger points 352, 364, 376, 388, 356, 368, 380, 392, 360, 372, 384, 395 on the power waveform. Each of these initiating exposure control signals is transmitted to the camera 126 to initiate exposure of the light sensor array in the camera 126 to the light energy emanating or reflecting from the welding region 109 (FIG. 1) for the respective exposure time periods 304, 310, 316, 322, 306, 312, 318, 324, 308, 314, 320, 326 to produce the respective raw images 304′, 310′, 316′, 322′, 306′, 312′, 318′, 324′, 308′, 314′, 320′, 326′. The vision system controller 124 also creates and sends terminating exposure control signals to the camera 126 to terminate the respective exposure time periods 304, 310, 316, 322, 306, 312, 318, 324, 308, 314, 320, 326 for the raw images 304′, 310′, 316′, 322′, 306′, 312′, 318′, 324′, 308′, 314′, 320′, 326′. As explained above for the FIG. 2 example, the four raw images 304′, 310′, 316′, 322′ are amalgamated together to create a first composite image 397; the next four raw images 306′, 312′, 318′, 324′ are amalgamated together to create the second composite image 398; and the next four raw images 308′, 314′, 320′, 326′ are amalgamated together to create the third composite image 399.

As also explained above for the FIG. 2 example, the vision system controller 124 creates progressively longer exposure time periods 304, 310, 316, 322 for the raw images 304′, 310′, 316′, 322′ that are used to create the first composite image 397. Likewise, the vision system controller 124 creates progressively longer exposure time periods 306, 312, 318, 324 for the raw images 306′, 312′, 318′, 324′ that are used to create the second composite image 398, and it creates progressively longer exposure time periods 308, 314, 320, 326 that are used to create the third composite image 399. The respective exposure time periods 304, 306, 308 for the first raw images 304′, 306′, 308′ used to create the respective composite images 397, 398, 399 have the same duration and occur in the same phase of the power waveform 302 as each other. Likewise, the respective exposure time periods 304, 306, 308 for the second raw images 310′, 312′, 314′ used to create the respective composite images 397, 398, 399 have the same duration and occur in the same phase of the power waveform 302 as each other; the respective exposure time periods 304, 306, 308 for the third raw images 316′, 318′, 320′ used to create the respective composite images 397, 398, 399 have the same duration and occur in the same phase of the power waveform 302 as each other; and the respective exposure time periods 322, 324, 326 for the third raw images 304′, 306′, 308′ used to create the respective composite images 397, 398, 399 have the same duration and occur in the same phase of the power waveform 302 as each other. Accordingly, the exposure time periods 304, 310, 316, 322 for the four raw images 304′, 310′, 316′, 322′ that are used to create the first composite image 397 are terminated at the respective terminating points 354, 366, 378, 390 on the power waveform 302; the exposure time periods 306, 312, 318, 324 for the next four raw images 306′, 312′, 318′, 324′ that are used to create the second composite image 398 are terminated at the respective terminating points 358, 370, 382, 394 on the power waveform 302; and the exposure time periods 308, 314, 320, 326 for the next four raw images 308′, 314′, 320′, 326′ that are used to create the third composite image 399 are terminated at the respective terminating points 362, 374, 386, 396 on the power waveform 302.

Consequently, comparing the exposure time periods 204, 210, 216, 222, 206, 212, 218, 224, 208, 214, 220, 226 in the FIG. 2 example to the exposure time periods 304, 310, 316, 322, 306, 312, 318, 324, 308, 314, 320, 326 in the FIG. 3 example, the raw images 304′, 310′, 316′, 322′, 306′, 312′, 318′, 324′, 308′, 314′, 320′, 326′ that are used to create the first, second, and third composite images 397, 398, 399 in FIG. 3 occur at different phases of the power waveform 302 than the phases of the power waveform 202 at which the exposure time periods 204, 210, 216, 222, 206, 212, 218, 224, 208, 214, 220, 226 occur. Since the intensities of light as well as physical features produced by the welding system 102 in the welding region 109 (FIG. 1) vary as a function of the varying voltage, current, or impedance associated with the power waveform, the raw images 304′, 310′, 316′, 322′, 306′, 312′, 318′, 324′, 308′, 314′, 320′, 326′ produced by the camera 126 in the FIG. 3 example will capture different physical features and light intensities in the welding region 109 than the raw images 204′, 210′, 216′, 222′, 206′, 212′, 218′, 208′, 214′, 220′, 226′ in the FIG. 2 example. Also, the delay in the FIG. 3 example between the detections of the exposure initiating threshold voltage at the voltage threshold points 328, 330, 332, 334, 336, 338, 340, 342, 344, 346, 348, 350 and the actual initiating trigger points 352, 364, 376, 388, 356, 368, 380, 392, 360, 372, 384, 395 can be varied by the vision system controller 124, either automatically or by manual input from the user interface 128, as a user observes the resulting composite images 397, 398, 399, . . . , N to see different features in the welding region 109 or to find optimum settings for the desired image quality for the features that the user wants to observe in the composite images 397, 398, 399, . . . , N.

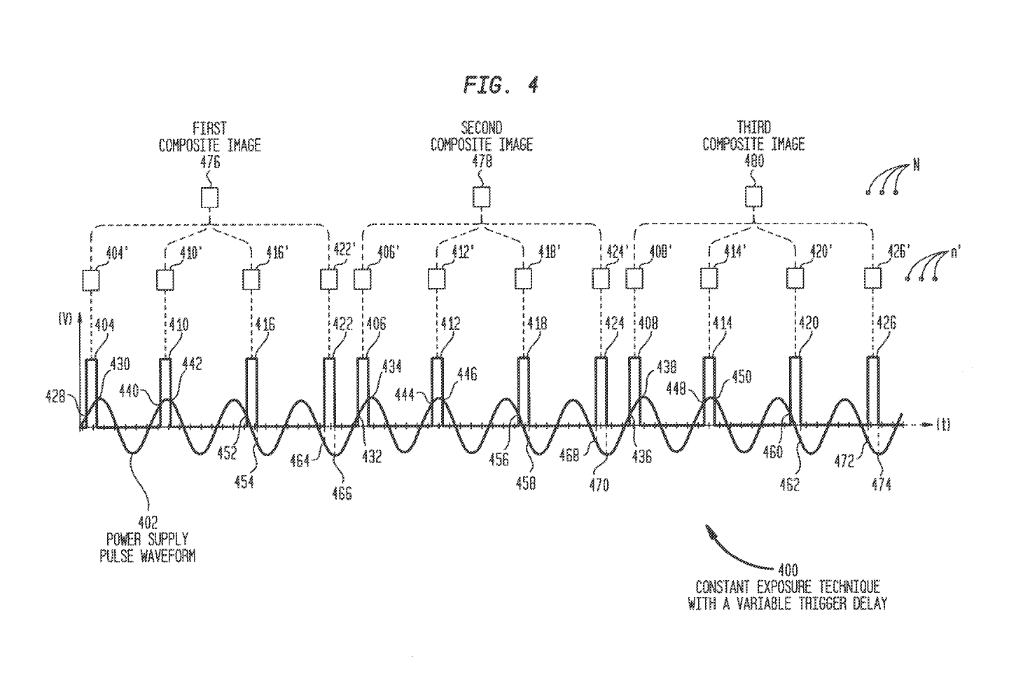

An example constant exposure technique 400 with a variable exposure initiation delay is illustrated in FIG. 4, again with a sinusoidal power waveform 402 similar to the sinusoidal power waveforms 202 and 302 in the FIGS. 2 and 3 examples for convenience and comparison. The constant exposure example 400 of FIG. 4 illustrates the capture of raw images, e.g., raw images 404′, 410′, 416′, 422′, 406′, 412′, 418′, 424′, 408′, 414′, 420′, 426′, with constant exposure time periods, i.e., where the exposure time periods 404, 410, 416, 422, 406, 412, 418, 424, 408, 414, 420, 426 for the raw images 404′, 410′, 416′, 422′, 406′, 412′, 418′, 424′, 408′, 414′, 420′, 426′ all have the same duration as each other, but at different portions or phases of the power supply waveform 402. As illustrated in FIG. 4, a first exposure time period 404 extends over a portion (phase) of the power supply waveform 402 between the initiating trigger point 428, at which the vision system controller 124 signals the camera 126 to initiate the exposure of the light sensor array in the camera 126 to light emanating or reflecting from the welding region 109, and the terminating trigger point 430, at which the vision system controller 124 signals the camera 126 to terminate the exposure. The vision system controller 124 can use (detect) a threshold value, e.g., the voltage value at the initiating trigger point 428, to trigger an exposure initiating control signal to the camera 126, as disclosed above, to initiate the exposure. Likewise, each of the other exposure time periods 410, 416, 422, 406, 412, 418, 424, 408, 414, 420, 426 can be initiated at the respective initiating exposure points 440, 452, 464, 432, 444, 456, 468, 436, 448, 460, 472 by setting initiating voltage threshold values for use by the vision system controller 124 to trigger generation of the exposure initiating control signals to the camera 126 at those exposure initiating points. Since the durations of the exposure time periods 410, 416, 422, 406, 412, 418, 424, 408, 414, 420, 426 in this example exposure technique 400 are all the same as each other, the vision system controller 124 is set to generate exposure terminating control signals to the camera 126 at that same predetermined amount of time after each of the respective exposure initiating points 428, 440, 452, 464, 432, 444, 456, 468, 436, 448, 460, 472. Accordingly, the exposure time periods 404, 410, 416, 422, 406, 412, 418, 424, 408, 414, 420, 426 are terminated by the vision system controller 124 at the respective terminating trigger points 430, 442, 454, 466, 434, 446, 458, 470, 438, 450, 462, 474 on the power waveform 402. Alternatively, the camera 126 itself can have a preset function to terminate the exposure in a predetermined exposure time period so that an exposure terminating control signal from the vision system controller 124 to the camera 126 is not needed to terminate the exposure time periods 404, 410, 416, 422, 406, 412, 418, 424, 408, 414, 420, 426. In another alternative, terminating threshold voltage values could be used by the vision system controller 124 to trigger exposure termination control signals to the camera 126 at the terminating trigger points 430, 442, 454, 466, 434, 446, 458, 470, 438, 450, 462, 474. In either case, the camera 126 produces each of the raw images 404′, 410′, 416′, 422′, 406′, 412′, 418′, 424′, 408′, 414′, 420′, 426′ with the same amount of time for each of the respective exposure time periods 404, 410, 416, 422, 406, 412, 418, 424, 408, 414, 420, 426. However, because some of those respective exposure time periods 404, 410, 416, 422, 406, 412, 418, 424, 408, 414, 420, 426 are initiated at different threshold voltages on the power waveform 402, they occur over different portions (phases) of the power waveform 402. This example exposure technique 400 is illustrated with the initiating trigger points 428, 432, 436 at a first initiating voltage threshold value, with the initiating trigger points 440, 444, 448 at a second initiating voltage threshold value, with the initiating trigger points 452, 456, 460 at a third initiating voltage threshold value, and with the initiating trigger points 464, 468, 472 at a fourth initiating voltage threshold value. Consequently, the raw images 404′, 406′, 408′ have the same exposure time over the same first portion (phase) of the power waveform 402; the raw images 410′, 412′, 414′ have the same exposure time over the same second portion (phase) of the power waveform 402; the raw images 416′, 418′, 420′ have the same exposure time over the same third portion (phase) of the power waveform 402; the raw images 422′, 424′, 426′ have the same exposure time over the same fourth portion (phase) of the power waveform 402; and those first, second, third, and fourth portions (phases) of the power waveform 402 are different than each other. As a result, the saturation of light sensors in the light sensor array can be controlled by setting a specific, fixed exposure time and triggering the exposure when the desired light intensity is being produced by the weld, because higher voltages in the power waveform 402 produce brighter arcs 107 and plasmas 108, and lower voltages in the power waveform 402 produce dimmer arc 107 and plasmas 108.

As mentioned above, the intensities of light energy emanating and reflecting from the welding region 109 and even physical characteristics of the welding region 109, e.g., melting, droplets, plasma size, spatter, etc., vary as a function of electrical characteristics of the welding power waveform. Therefore, the light intensities, features, and characteristics of the welding region 109 that are captured by the raw images 404′, 406′, 408′ during that first portion (phase) of the power waveform 402 are different in some respects than the light intensities, features, and characteristics captured by the raw images 410′, 412′, 414′ during the second portion (phase) of the power waveform 402, even though the durations of their exposure time periods 404, 406, 408, 410, 412, 414 are the same. Likewise, the light intensities, features, and characteristics of the welding region 109 captured by the other raw images during exposure time periods that extend over different portions (phases) of the power waveform 402 will be different in some respects.

Similar to the explanations above for the techniques 200 and 300 in FIGS. 2 and 3, the raw images 404′, 410′, 416′, 422′ obtained during the respective exposure time periods 404, 410, 416, 422 are amalgamated to create the first composite image. Likewise, the raw images 406′, 412′, 418′, 424′ obtained during the respective exposure time periods 406, 412, 418, 424 are amalgamated to create the second composite image 478, and the raw images 408′, 414′, 420′, 426′ obtained during the respective exposure time periods 408, 414, 420, 426 are amalgamated to create the third composite image 480. These processes can be repeated indefinitely to obtain additional raw images represented by the dots n′ to create additional composite images represented by the dots N for as long as a user desires. As also explained above, the aperture of the camera 126, the sensitivity of the light sensors in the light sensor array of the camera 126, and the amount of darkening of the optional darkening plate 130 can all be varied, either individually, or in any combination, to achieve light levels so that at least some of the various pixels of the raw images produced by the camera 126 are not saturated or dark.

As explained above, one of the goals of creating the composite images, such as the composite images 253, 255, 257 of the FIG. 2 example, the composite images 397, 398, 399 of the FIG. 3, example, and the composite images 476, 478, 480 of the FIG. 4 example, is that the welding region 109 (FIG. 1) and specific features in the welding zone 109, e.g., the weld bead 103, welder nozzle 104, electrode 106, arc 107, plasma 108, puddle 111, work pieces 110, 112, and droplets 121, can be imaged with high resolution. In this manner, the composite images show all of the different portions of the welding region 109 and provide valuable information regarding the quality of the weld bead 103. With such information, adjustments can be made to the parameters of the welding process to ensure a high quality weld. For example, the electric current in the portions of the work pieces 110, 112 that are juxtaposed to the electrode 107 should create enough heat to create a melt zone 113 of molten metal, the droplets 121 should be melted from the distal end of the electrode 107 in a uniform manner and deposited in the weld puddle 111 with minimal if any spatter, the weld puddles 121 should be sufficiently liquid and of a high enough temperature to fuse with the melt zone 113 in the work pieces 110, 112 at the intersection of the work pieces 110, 112, and the resulting weld bead 103 should be smooth and uniform with no visible porosity. In addition, the location of the welding tip (not seen in the nozzle 104) and, accordingly, the electrode 106 must be correct and the droplets 121 should fall or be deposited at or near the intersection of the work pieces 110, 112 that are being joined by the weld. By being able to view the welding pieces 110, 112, which are typically darker in the welding region 109, as well as the much brighter plasma, droplets 121, puddle 111, and other features together in one image, the weld bead 103 can be formed accurately and with high quality characteristics at the intersection of the welding pieces 110, 112. By adjusting the sensitivity of the detectors in the camera 126, aperture opening, and/or using the dynamic darkening plate 130, at least some of the raw images can be obtained with a sufficient amount of light to create images without saturation. Of course, lights 134 (FIG. 1) can be mounted on the camera 126 or other convenient location to provide supplemental illumination for background and darker features in the welding region 109 such as the work pieces 110, 112 or the weld bead 103 for supplemental illumination to an adequate amount of light can be collected to image the background area, such as welding pieces 110, 112. These goals and principles also apply to composite images created by other techniques discussed in more detail below.

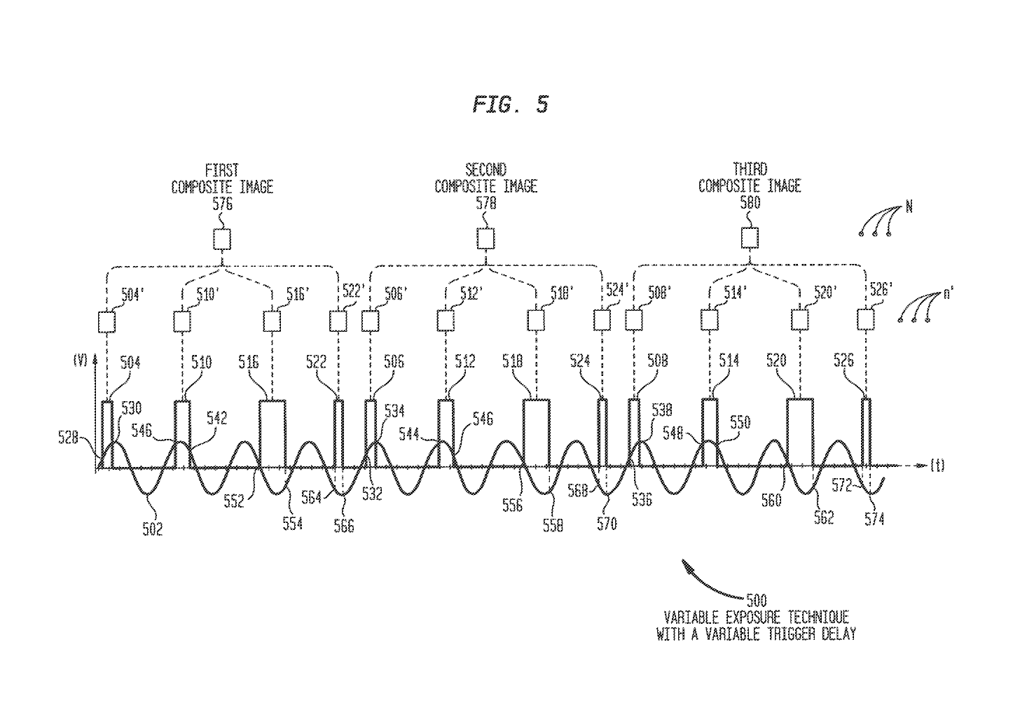

An example variable exposure technique 500 is illustrated in FIG. 5 with a variable initiating trigger delay. For convenience and comparison, the power waveform 502 in FIG. 5 is illustrated as sinusoidal, similar to the power waveforms 202, 302, 402 in the FIGS. 2, 3, and 4 examples. The example technique 500 in FIG. 5 is similar to the example technique 400 FIG. 4 in that raw images 504′, 510′, 516′, 522′, 506′, 512′, 518′, 524′, 508′, 514′, 520′, 526′, . . . , n′, like the raw images 404′, 410′, 416′, 422′, 406′, 412′, 418′, 424′, 408′, 414′, 420′, 426′, . . . , n′, are obtained during different portions (phases) of the power supply waveform 502. However, the exposure time periods 504, 510, 516, 522, 506, 512, 518, 524, 508, 514, 520, 526 have different durations, whereas the durations of the exposure time periods 404, 410, 416, 422, 406, 412, 418, 424, 408, 414, 420, 426 are all the same. In the example technique 500, the first four exposure time periods 504, 510, 516, 522 have different durations, i.e., the exposure time period 516 is longer than the exposure time period 510, which is longer than the exposure time period 504, which is longer than the exposure time period 522. Likewise, the exposure time periods 506, 508 have the same duration as the exposure time period 504; the exposure time periods 512, 514 have the same duration as the exposure time period 510; the exposure time periods 518; 520 have the same duration as the exposure time period 516; and the exposure time periods 524, 526 have the same duration as the exposure time period 522. As with the other example exposure techniques 200, 300, 400 in FIGS. 2, 3, and 4, the initiating trigger points 528, 546, 552, 564, 532, 544, 556, 568, 536, 548, 550, 572 and the terminating trigger points 530, 542, 554, 566, 534, 546, 558, 570, 538, 550, 562, 574 can be established by either clock timing or detecting threshold voltages or other electrical characteristics of the power waveform 502. As also explained above for the example techniques 200, 300, 400 in FIGS. 2, 3, and 4, the raw images exposure time periods 504′, 510′, 516′, 522′ created by the camera 126 during the respective exposure time periods 504, 510, 516, 522 are amalgamated to create the first composite image 576; the raw images 506′, 512′, 518′, 524′ created by the camera 126 during the respective exposure time periods 506, 512, 518, 524 are amalgamated to create the second composite image 578; and the raw images 508′, 514′, 520′, 526′ created by the camera 126 during the respective exposure time periods exposure time periods 508, 514, 520, 526 are amalgamated to create the third composite image 578. The composite images 253, 255, 257 in the FIG. 2 example 200, the composite images 397, 398, 399 in the FIG. 3 example 300, the composite images 476, 478, 480 in the FIG. 4 example 400, and the composite images 576, 578, 580 in the FIG. 5 example 500 can be formed with any desired process of combining the respective raw images. For example, each individual pixel from each individual raw image can be statistically evaluated based upon how close each individual pixel is to saturation or to complete darkness. Other techniques can be used, such as selecting pixels that have a predetermined location in the raw image for use in the composite image based upon the particular exposure being used. For example, pixels may be selected from the center of the detector array for an initial exposure, if that exposure period is very short, and from peripheral areas of the detector array during long exposures, so that the background areas can be viewed. Numerous other techniques can be used for the image combining process.

In another example implementation of the Example 2, 3, 4, and 5 techniques described above, the exposure initiating control signals and the exposure terminating control signals described above can be provided by the welding power supply 122 to the camera 126 as indicated by the alternate cameral control link 148 in FIG. 1, instead of by a separate vision system controller 124. Features and capabilities similar to those of the vision system controller 124 for providing such signals to the camera can be built into the welding power supply 122. In another implementation, the vision system controller can receive signals from the welding power supply 122 and respond to such signals to generate the exposure initiating control signals and the exposure terminating control signals to the camera 126. Therefore, the vision system controller 124 can be an integral part of the welding power supply 122.

In one embodiment, which can be utilized with the example techniques shown in FIGS. 2, 3, 4, and 5, the frequency of the power waveform, e.g., the power waveform 202 in FIG. 2, may be set, for example, at 110 Hz. Of course, any desired frequency can be used for the power supply waveform 202 that will provide exposure time periods appropriate for a particular application, and 110 Hz is given by way of example only. In this FIG. 2 example, each of the combined composite images 253, 255, 257 is created at approximately one-fourth of the frequency of the power supply waveform 202, which is a rate of approximately 27 images per second. Standard video is approximately 30 images (frames) per second, Blu-ray is 24 images per second, and motion pictures are approximately 25 images per second. As such, a very viewable video can be created using a power supply waveform 202 that, in this example, as a frequency of approximately 110 Hz.

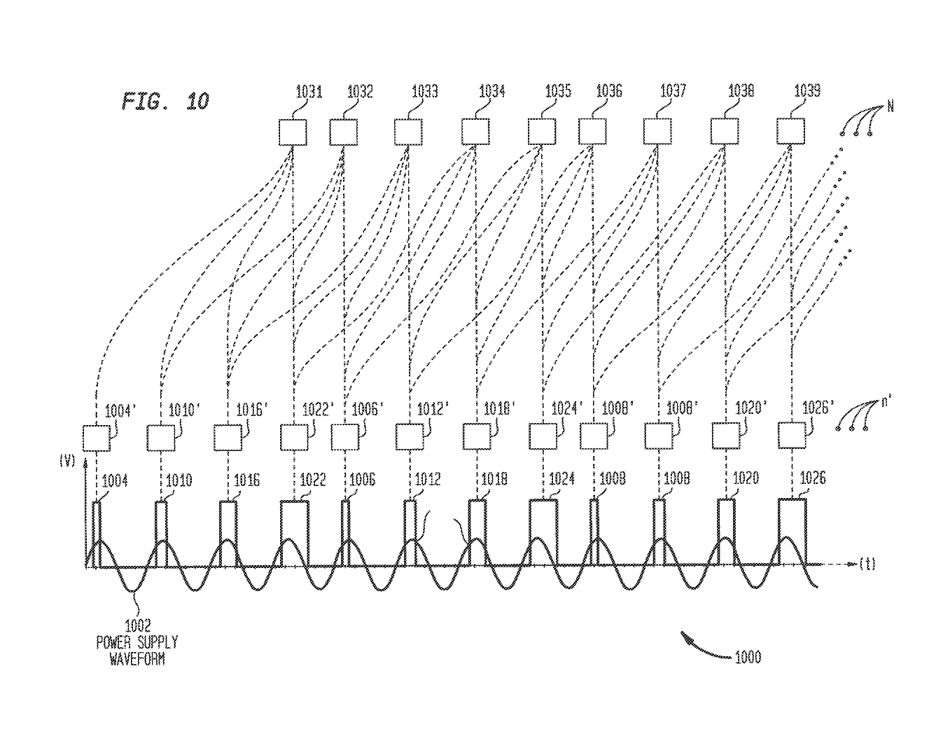

FIG. 6A is a flow diagram 600 that illustrates an example operation of the welding vision and control system 100 for generating images of welds, such as the composite images created in the FIGS. 2, 3, 4, and 5 examples above. At step 602, the controller 124 of the welding vision and control system 100 obtains operating parameters for operation of the welding vision and control system 100. The vision system controller 124 may read these operating parameters from storage. In a computer system, such storage may be RAM or disk storage or other storage, such as EEPROM, or similar storage for hardware implementations. The user interface 128 can also be used to provide these operating parameters. In one embodiment, the vision system controller 124 may comprise a general purpose computer that may store a series of different operating parameters that allow the welding vision and control system 100 to operate in various modes to produce various images. For example, various modes of operation or techniques are illustrated in FIGS. 2-5. In this context, the example techniques 200, 300, 400, 500 in FIGS. 2, 3, 4, and 5 are also referred to as modes of operation. Of course, other modes of operation may be selected also. In other embodiments, there may be only one or two modes of operation and the systems may be preloaded with the operating data. For example, in the manual welding vision system 1000 embodiment illustrated in FIG. 10, the operating parameters of the system may be loaded into hardware, such as EEPROM or similar storage, and accessed by a processor to obtain the data and operate the welding vision system 1000 in accordance with the various embodiments or techniques disclosed herein. For example, in the manual welding vision system 1000 embodiment of FIG. 10, the vision system controller 124 in FIG. 1 may be enclosed in a simple small electronics package 1008 mounted on a helmet 1002 or other convenient location. The electronics package 1008 includes EEPROM storage, or other similar storage, containing operating parameters, a microprocessor, a state machine, and other electronics. In addition, or alternatively, field programmable gate arrays (FPGA) and other logic circuitry can be used in the small electronics package 1008 that may provide only one, or possibly two different, modes of operation.

Referring again to FIG. 6A, once the operating parameters have been obtained for operation of the welding vision and control system 100, the process proceeds to step 604 to select a set of operating parameters from several different modes of operation. Again, if only a single mode of operation is utilized, such as in the manual welding vision system 1000 embodiment in FIG. 10, step 604 can be eliminated. The process then, at step 606, applies the operating parameters to operate the system, including the camera 126. The operation of the camera 126, including the setting of various exposure time periods, aperture, sensitivity, and optional dynamic darkening plate 130, as well as the logic associated with generating the composite images, are performed by the vision system controller 124. At step 608, raw images of the welding region 109 are generated by the camera 126. These raw images are synchronized with the welding process by synchronizing the capture of the raw images with the power supply waveform in the manner described above. In other words, the raw images are generated by the camera 126 in response to the power waveform in the manner described above. As such, successive raw images are synchronized with the power waveform to produce streams of raw images that are synchronized with, the chronological occurrences of the welding process in optimized to capture particular features in the welding region 109 in rapid enough fashion to enable creation of a stream of composite images showing all or particular features in the welding region 109 in real time as the welding process progresses. Accordingly, the images do not skip around, but provide a consistently stable view of each feature as it evolves in chronological occurrences in the weld process.

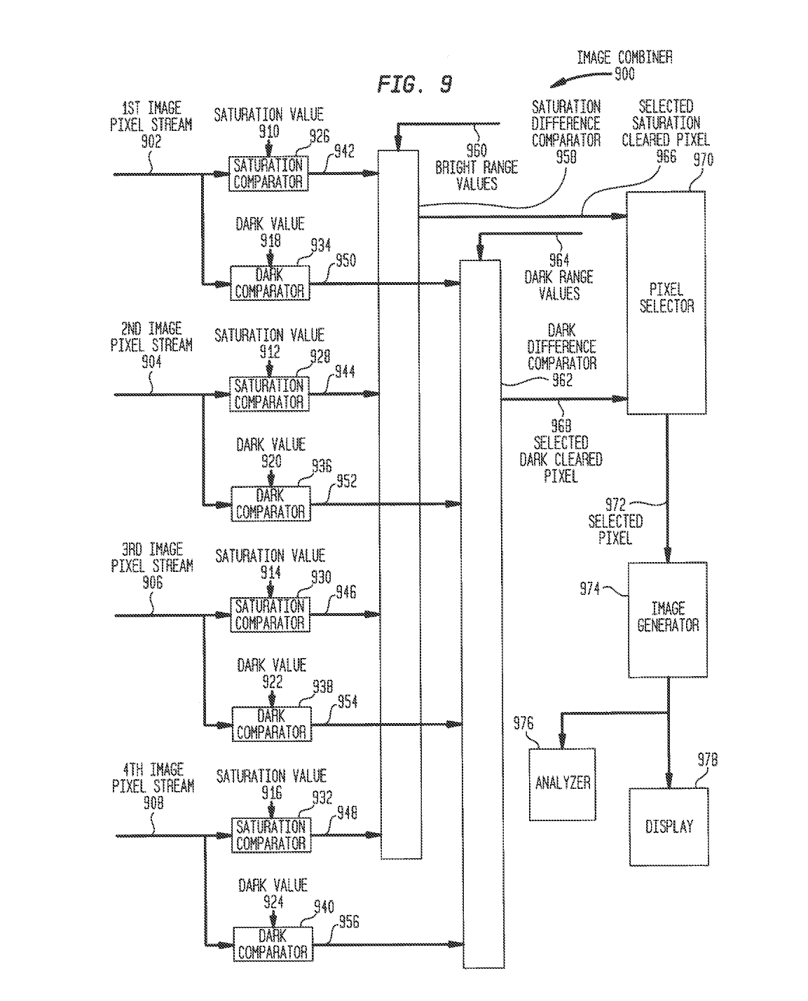

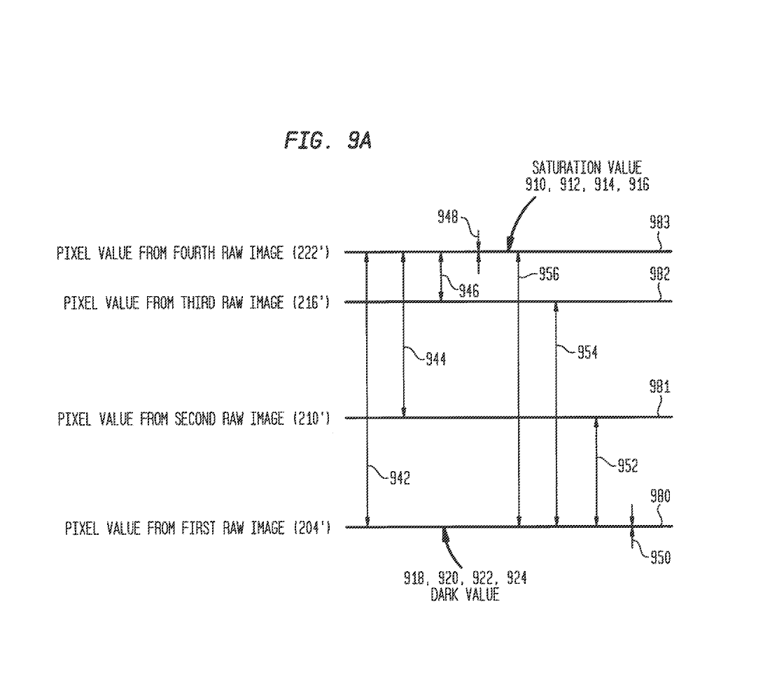

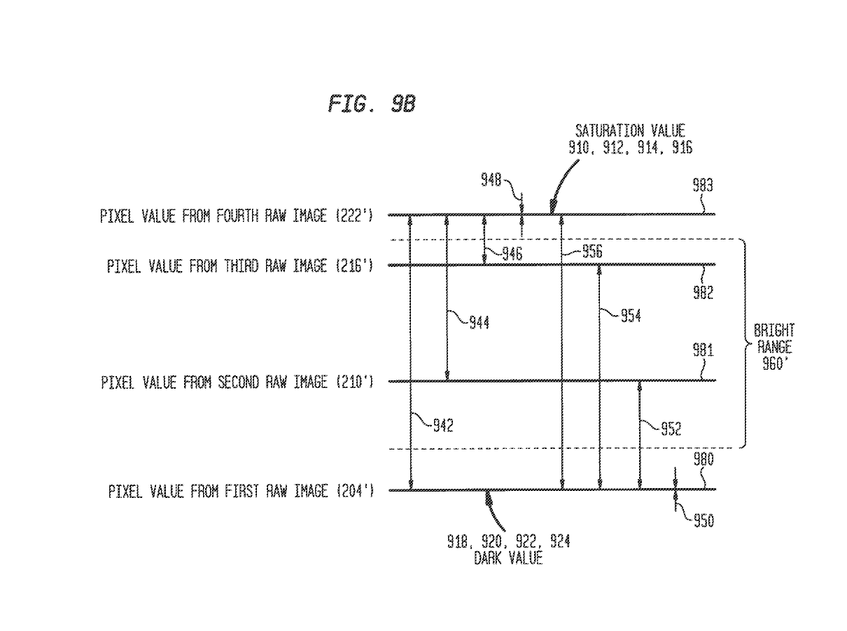

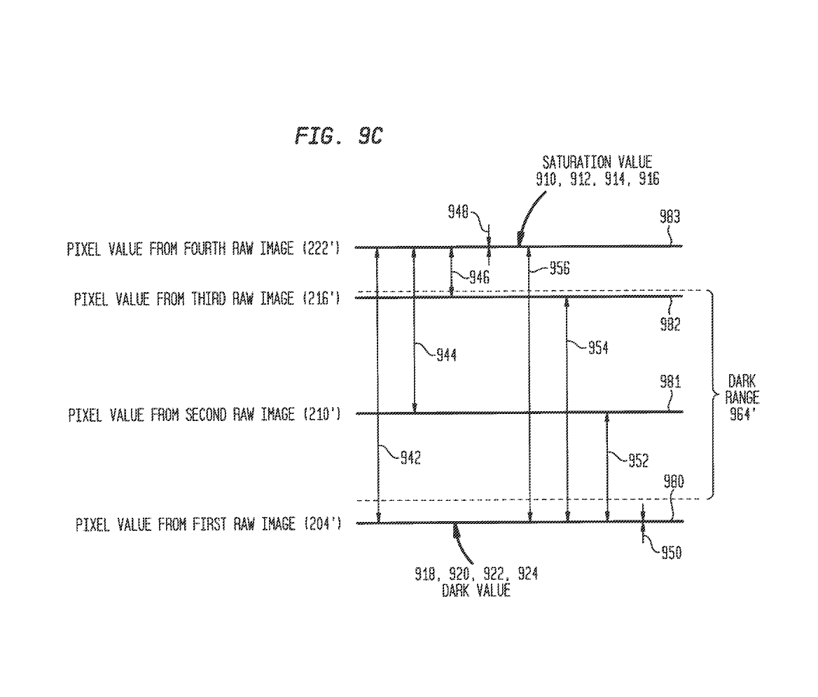

With continuing reference to FIG. 6A, at step 610, the composite images are combined to create a substantially real time video of the welding process. In that regard, the composite images are simply displayed at the rate at which they are created, in accordance with any desired method of combining the images to create the desired composite images to provide a real time video of the welding process. One example of a hardware implementation for combining raw images into the composite images is shown in FIG. 9 and explained below. Depending upon the frame rate, either hardware or software implementations may be used to combine the raw images. At step 612, the composite images are displayed as a video. The composite images can also be analyzed, either automatically or by an observer, to determine if any of the welding parameters should be changed. For example, the composite images can be viewed to determine if the position of the welding tip and electrode should be modified, or if the voltage or current of the power waveform or the speed of the welding tip should be changed. Other parameters may also be modified.

As also shown in FIG. 6A, the video can be viewed and/or analyzed by an automated system, such as a machine vision system with or without some form of pattern recognition, depending on what aspects of the weld or welding process are used for such analysis. Machine vision and pattern recognition techniques have been well developed, are available commercially, e.g., pattern recognition libraries for the MATLAB (trademark) software platform. For example, the shape and size of the weld bead 103 (FIG. 1) itself provides a great deal of information relating to the quality of the weld. The formation of the weld droplets 121 and development of the weld puddles 111 during the welding process can be observed and analyzed using machine vision or pattern recognition techniques to modify the current or voltage of the power waveform produced by the welding power supply 122. The size and location of the droplets 121 formed in the welding process, and the deposition of these droplets 121 in the welding process, can provide information regarding the modification of the location and spacing of the welding tip in relation to the work pieces 110, 112. The image of the welding electrode 106 with respect to the work pieces 110, 112 also enables modification of the location of the welding tip and electrode 106 in an automated manner. In that regard, the distance of the weld tip and electrode 106 from the work pieces 110, 112 or from the weld puddle 111 can also be observed and modified in an automated manner. In reciprocating wire arc welding, the wire electrode 106 is reciprocated to move upwardly away from the weld puddle 111 as the droplet 121 forms on the distal end of the wire electrode 106 and then downwardly to deposit the formed droplet 121 neatly into the puddle 111, so machine vision and pattern recognition could be used to monitor that process and automatically adjust power waveform parameters and wire electrode 106 reciprocating parameters to ensure that the droplets are fully formed and separate from the wire electrode 106 only directly into the puddle 111 and not above the puddle 111. As another example, pattern recognition software may be designed to detect a light emission around the weld puddle 111 that shows the melting zone 113 of the welding pieces 110, 112 surrounding the puddle 111. These melting zones 113 would appear as a curved area emitting light that is just at the edge of the puddle 111. Again, the existence of this light emission and the intensity of the emission can be used to determine the quality of the weld 103. Also, the height and width of the weld bead 103 can be determined using machine vision techniques to determine the quality of the weld and to make adjustments to the welding process, such as modifying the current, or modifying the speed or position of the welding head to obtain the desired size and shape, uniformity, etc., of the weld bead 103. Such machine vision and pattern recognition functions can be applied to the composite images by the vision system controller 124 loaded with appropriate machine vision and pattern recognition applications and parameters. When the vision system controller 124, applying such machine vision and pattern recognition processes to the composite images identifies a condition or feature in the welding process that needs adjustment, the vision system controller 124 outputs signals to the welding power supply 122 or to the robot system controller 142, or both, to modify the parameters or conditions that need to be modified. For example, waveform control signals from the vision system controller 124 to the welding power supply can cause the welding power supply 122 to adjust or modify any electric parameter of the power supply waveform 136, e.g., voltage, current, frequency, modulation, shape (rise, peak, background, and tail-out slopes, amplitudes, etc.), impedance, or other characteristics. Position control signals from the vision system controller 124 to the robot system controller 142 can cause the robot system controller 142 to output signals to the robot system actuators to move the welder nozzle 104, tip in the nozzle, and electrode 106 in any direction and to any orientation or aspect in relation to the welding pieces 110, 112, for example, through appropriate mechanical linkages 146, depending on the type of welding and type of work pieces for any particular welding job. Such robotic welding systems with various actuators 144 and linkages 146 as well as robot system controllers with control software and firmware are well-known and available commercially. Alternatively, the robot controller software can be implemented in the vision system controller 124. Other parameters of the welding process can also be analyzed and adjusted automatically by applying machine vision and pattern recognition processes to the composite images. Alternatively, in a simpler implementation, the vision system controller 124 can output an alarm or notice through the display device 138 or some other separate alarm or notification system (not shown) when the machine vision and pattern recognition processes applied to the composite images identifies a condition or feature in the welding process that needs adjustment

The process of FIG. 6A then proceeds to step 614, at which point it is determined whether a different mode of operation should be utilized for the imaging system. A different mode, for example, the technique 200, 300, 400, or 500 shown in FIG. 2, 3, 4, or 5, or another technique, may be selected by a user, or this process may be determined in an automated fashion. For example, a first mode of operation may not provide sufficient definition or usable information of the darker features in the welding region 109 (FIG. 1), such as the weld bead 103 or the work pieces 110, 112. This determination can be made by simply viewing the composite images or a video made with the composite images, or it may be determined automatically by machine vision measuring the light level of the pixels around the periphery of the composite images or other automated process. A different mode of operation of the welding vision and control system may provide better illumination or light capture from such darker regions with longer exposure time periods or with exposure time periods extending over different portions (phases) of the power waveform as explained above. In another example, the saturation of the image in areas around the welding tip, e.g., at the electrode 106 or in the plasma 108, may not provide a clear image of those features or of droplets 121 forming on the distal end of the electrode 106 or being deposited in the welding puddle 111. In this case, a different mode of operation may be selected that better captures raw images of those features for use in creating the composite images. Again, several example modes of operation are illustrated by the techniques in FIGS. 2-5. These modes may be preset in the vision system controller 124, so that the vision system controller automatically uses the parameters set for those modes, or data can be entered through the user interface 128 to modify the modes of operation. If it is determined that a different mode of operation should be used for the welding vision and control system 100, the process in FIG. 6A returns to step 604, where a set of operating parameters is selected from several different modes, or a mode is simply entered into the user interface 128. In that regard, the user interface 128 may store and apply preset modes into the welding vision and control system 100.

If it is determined, at step 614 of the flow diagram illustrated in FIG. 6A that a different mode is not to be used, the process proceeds to step 616, where it is determined if the weld is satisfactory. If the weld is satisfactory, then the process returns to step 612 so that the video can continue to be displayed and analyzed. If it is determined, at step 616, that the weld is not satisfactory, the process proceeds to step 618, where the welding system parameters are modified. The process then returns to step 608, in which the composite images of the adjusted welding process are generated.

FIG. 6B is a flow diagram 650 that illustrates an example operation of the vision system controller 124. The steps illustrated in FIG. 6B may be carried out by a computing system, embedded processor, or logic hardware, such as field programmable gate arrays (FPGAs). As disclosed in FIG. 6B, the vision system controller 124 reads the threshold values at step 652 for the power supply waveform. The vision system controller 124 then reads the delays, if any, associated with one or more exposures, as disclosed in FIGS. 2-5, at step 654. At step 656, the controller reads the exposure time periods. All of this data may be stored in RAM or ROM storage, or, in hardware implementation, in EEPROMs, or in other storage. If the exposure time periods are not provided in clock pulses, the vision system controller 124 may calculate the number of clock pulses for each exposure, at step 658. At step 660, the vision system controller 124 reads the detector sensitivity data. As disclosed above, the detectors of the light sensor array in the camera 126 may have adjustable sensitivity. The sensitivity of these detectors in the camera 126 can be adjusted to be more or less sensitive to the light incident on the light sensor array. Data regarding the sensitivity can be stored for each of the exposure time periods, such as illustrated in FIGS. 2-5, so that the sensitivity can be changed for each of the exposure time periods. Alternatively, a single sensitivity can be selected for all of the exposure time periods. At step 662, the vision system controller 124 reads the aperture data. The aperture data can be changed for each of the exposure time periods to adjust the amount of light that is incident on the light sensor array of the camera 126. At step 664, the vision system controller 124 generates an exposure initiating control signal to the camera 126 to initiate exposure of the light sensor array to light energy emanating or reflecting from the welding region 109. The exposure initiating control signal to initiate the exposure can be generated in response to the welding power waveform reaching a threshold value, or in response to a delay from the time that the power waveform reaches a threshold value as explained above. At step 668, the vision system controller generates an exposure terminating control signal to the camera 126 to terminate the exposure of the light sensor array to light energy emanating or reflecting from the welding region 109 when the number of clock pulses is reached for each exposure time period. Alternatively, an exposure terminating threshold can be used to trigger generation of the exposure terminating control signal to the camera 126. At step 670, control signals are generated to adjust the sensitivity and aperture in accordance with the sensitivity data and aperture data read by the vision system controller 126. Again, the control signals can be generated for each exposure time period. At step 672, the control signals are applied to the camera 126. The camera 126 then adjusts all of the parameters in accordance with the control signals. At step 674, the image data from the camera 126 for each of the raw images produced during each exposure time period is received by the vision system controller 124. At step 676, the vision system controller 126 combines the individual images into composite images using various logic functions. Again, these logic functions can be any desired logic functions for combining the pixels of each of the individual raw images in each set of images to obtain the desired composite images. At step 678, the composite images are displayed for viewing.

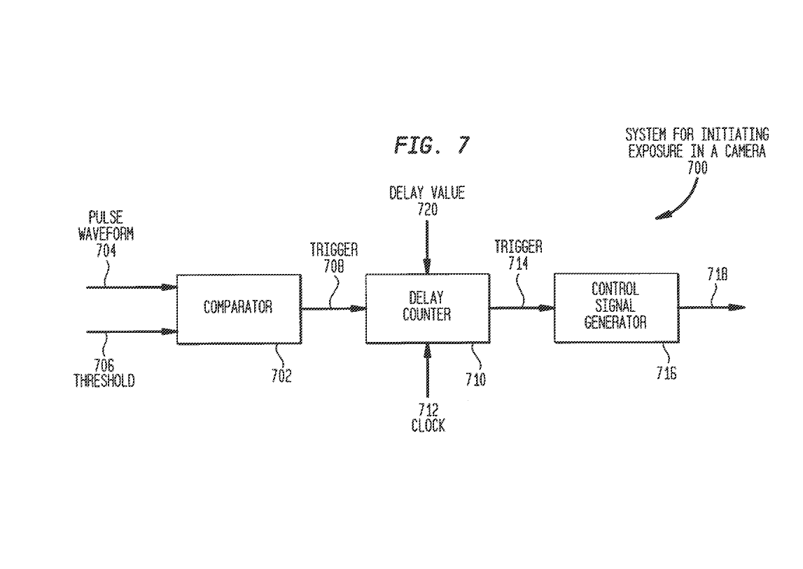

FIG. 7 illustrates an example system 700 for initiating exposure of the light sensor array of the camera 126 to the light energy emanating or reflecting from the welding region 109. As illustrated in FIG. 7, the power waveform 704, as well as a threshold value 706, is applied to a comparator 702. The comparator 702 compares the magnitude of an electrical characteristic of the power waveform 704, e.g., voltage, with the threshold value 706. When these values match, the comparator 702 generates an exposure initiating trigger signal 708. The exposure initiating trigger signal is then applied to a delay counter 710. The delay counter counts a number of clock pulses 712, if any, until the delay value 720 is reached. The delay counter 710 then generates a trigger 714. The trigger 714 is applied to the control signal generator 716, which generates a control signal 718 that is applied to the camera 126. Of course, the system illustrated in FIG. 7 can operate without the delay counter 710. The delay counter 710 provides more flexibility, especially when the delay value 720 can be modified. Modified delay value 720 can be used in different modes of operation of the welding vision and control system 100.

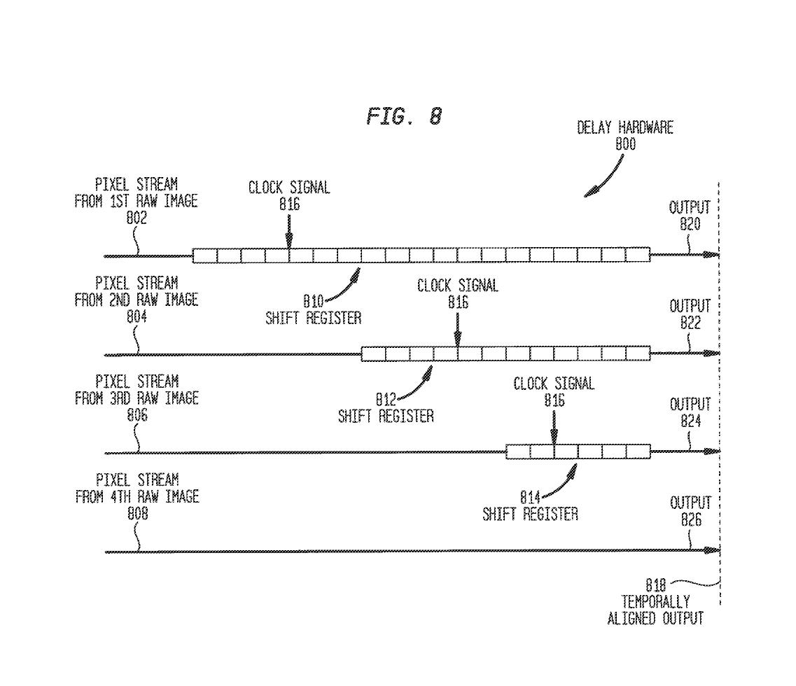

In the example operational modes (techniques) illustrated in FIGS. 2, 3, 4, and 5, sets of four sequential raw images are combined in some manner into composite images. For example, as described above, the first four raw images 204′, 210′, 216′, 222′ are combined to create the first composite image 253. The combining process is repeated for combining subsequent raw images into composite images. While four raw images are shown in the FIGS. 2, 3, 4, and 5 examples to be combined to create one composite image, any number of raw images can be used to create a composite image. Electronic values produced by individual sensors of two-dimensional sensor arrays are produced as a raster of pixel light intensity values of the image and are commonly read out of the light sensor array in a raster scan, e.g., in a series of individual pixel data values read out line by line of the raster, typically beginning with the pixel value in one corner of the raster and progressing line by line to the last pixel value in the opposite corner of the raster. An example system that can be used to temporally align corresponding pixels from the four raw images for combination into a composite image is shown schematically in FIG. 8. As shown in FIG. 8, three shift registers 810, 812 and 814 are used to temporally align the corresponding pixel values in the respective pixel streams 802, 804, 806 from the first, second, and third raw images of a set of four raw images used to create a composite image (e.g., the raw images 204′, 210′, 216′ used to create the composite image 253 in FIG. 2) with the pixel stream 808 from the fourth raw image used to create the composite image (e.g., the raw image 222′ which is also used in creation of the composite image 253 in FIG. 2). Effectively, the respective pixel streams of each of the first three raw images (e.g., raw images 204′, 210′, 216′) is progressively delayed in time by the respective shift registers 810, 812, 814 so that they align temporally with the pixel stream of the fourth raw image (e.g., raw image 222′). When the corresponding pixels values from the four pixel streams for the four raw images are temporally aligned, they can be put through an evaluation and selection process for selecting the particular pixel values from the four raw images (e.g., raw images 204′, 210′, 216′, 222′) that will be used to create the composite image (e.g., the composite image 253 in FIG. 2) as will be explained in more detail below.

As can be seen in FIG. 2, the raw image 204′ is completely created by the camera 126 at the time of the exposure terminating trigger 230, while the raw image 222′ is completely created by the camera 126 at the time of the exposure terminating trigger 266. In other words, the exposure is completed for each of these raw images 204′, 222′ at those respective points in time 230, 266, and the serial pixel streams for those raw images 204′, 222′ are transmitted by the camera 126 at the respective points in time 230, 266. Therefore, the pixel values for the raw image 204′ must be delayed by the amount of time between the exposure terminating trigger point 230 and the exposure terminating trigger point 266. The number of clock pulses is determined between those two exposure terminating trigger points 230, 266, and a shift register 810 is provided with that number of shift cells so that the pixel stream 802 from the first raw image 204′ is delayed by that amount of time. When the serial pixel stream 802 enters the shift register 810, the clock pulses 816 advance the pixel data through the shift register 810 to the output 820.

Similarly, the second pixel stream 804 from the second raw image (e.g., raw image 210′) is delayed by a predetermined amount. In this example, the delay is equal to the amount of time between the exposure terminating trigger point 242 for the second raw image 210′ and the exposure terminating trigger point 266 for the fourth raw image 222′. The shift register 812 shifts the pixel data stream 804 from the second raw image 222′ through the shift register in response to the clock signal 816. The number of cells in the shift register 812 is equal to the number of clock pulses between the exposure terminating trigger point 242 and the exposure terminating point 266. Pixel stream 806 in FIG. 8 is produced by the third raw image, e.g., raw image 216′ in FIG. 2). Shift register 814 shifts the serial pixel stream 806 in response to the clock signal 816. Pixel stream 808 from the fourth raw image is not delayed by a shift register. Pixel streams 802, 804, 806 are all temporally aligned with pixel stream 808. Consequently, the outputs 820, 822, 824, 826 comprise temporally aligned outputs 818. In other words, corresponding pixels for each of the four raw images (e.g., the raw images 204′, 210′, 216′, 222′ in FIG. 2), in a set of raw images that will form one combined image (e.g., the first composite image 253 in FIG. 2), are all temporally aligned at the output 818. In this manner, pixel values from corresponding pixels of each of the raw images in each set of raw images can be compared for selection of a single pixel value from each corresponding four pixels to use in creation of the combined image. The alignment device of FIG. 8 may not be required in a digital computer system implementation, since pixels in such systems may be stored with addresses and comparisons can be made based upon address locations.

FIG. 9 is a schematic illustration of one example embodiment of an image combiner 900. The four different pixel streams from the outputs 820, 822, 824, 826 from the FIG. 8, which are all temporally aligned at the output 818 of FIG. 8, are applied to the image combiner 900 in FIG. 9 and comprise first image pixel stream 902, second image pixel stream 904, third image pixel stream 906, and fourth image pixel stream 908, respectively. Accordingly, each of the individual raw images (e.g., the raw images 204′, 210′, 216′, 222′, in FIG. 2 make a set of four raw images that are used to create a composite image (e.g., the first composite image 252 in FIG. 2. The composite image may be created by selecting pixel values from the pixel streams of the four different raw images using the image combiner 900. The pixel stream 902 from the first raw image (e.g., raw image 204′) is applied to a saturation comparator 926 and a dark comparator 934. Each pixel of the first pixel stream 902 has a digital value that indicates the brightness or intensity of the incident radiation that illuminates that pixel of the raw image. That digital value is compared to a saturation value 910 to generate a delta signal 942 which indicates the difference between the saturation value 910 and the brightness or intensity of the light energy from the welding region 109 (FIG. 1) that was incident on that pixel when the light sensor array of the camera 126 was exposed to the light energy emanating or reflecting from the welding region 109. That difference signal 942 is applied to the saturation difference comparator 958. Each pixel in the pixel stream 902 is also applied to the dark comparator 934, which compares the brightness digital value of each of the pixels in the pixel stream 902 with a dark value 918. The dark value 918 may simply be zero, or it may constitute some other value selected by a user. Both the saturation value 910 and the dark value 918 can be input by a user through the user interface 128. Otherwise, these saturation and dark values may be stored in the saturation comparator 926 and the dark comparator 934. The difference signal 950, which indicates the difference between the dark value 918 and the intensity of the light energy from the welding region 109 that was incident on that pixel when the light sensor array of the camera 126 was exposed to the light energy emanating or reflecting from the welding region 109, is applied to the dark difference comparator 962.

Similarly, the second pixel stream 904 of the second raw image is applied to the saturation comparator 928 and to the dark comparator 936. Comparisons of the pixel values in that pixel stream 904 are made with the saturation value 912 and the dark value 920 to produce a saturation difference signal 944 and a dark difference signal 952. The saturation difference signal 944 is applied to the saturation difference comparator 958. The dark difference signal 952 is applied to the dark difference comparator 962.

Likewise, the third pixel stream 906 of the third raw image is applied to a saturation comparator 930 and a dark comparator 938. Saturation comparator 930 produces a saturation difference signal 946 that is applied to saturation difference comparator 958. The saturation difference signal 946 is the difference between the intensity of the incident radiation that illuminated the pixel in the light sensor array in the camera 126 during exposure and the saturation value 914. Pixel stream 906 is also applied to the dark comparator 938, which compares the intensity of the incident radiation that illuminated the pixel in the light sensor array in the camera 126 during exposure and the dark value 922 to produce a dark difference signal 954, which is applied to the dark difference comparator 962.

Likewise, the fourth pixel stream 908 of the fourth raw image is applied to the saturation comparator 932 and the dark comparator 940. Saturation comparator 932 produces a saturation difference signal 948 that is applied to saturation difference comparator 958. The saturation difference signal 948 is the difference between the intensity of the incident radiation that illuminated the pixel in the light sensor array in the camera 126 during exposure and the saturation value 916. Pixel stream 908 is also applied to the dark comparator 940, which compares the intensity of the incident radiation that illuminated the pixel in the light sensor array in the camera 126 during exposure and the dark value 924 to produce a dark difference signal 956, which is applied to the dark difference comparator 962.

The saturation values 910, 912, 914, 916 and the dark values 918, 920, 922, 924 can be fixed for a particular system, or they can be adjustable either manually or automatically with machine vision techniques,

In one example illustrated in FIG. 9A, the composite image 253 in FIG. 2 is amalgamated from four raw images 204′, 210′, 216′, 222′ as explained above. As also explained above, those four raw images 204′, 210′, 216′, 222′ in FIG. 2 were created by the camera 126 from progressively increasing exposure time periods 204, 210, 216, 222. Therefore, the pixel light sensors in the light sensor array in the camera 126 had progressively increasing exposure time periods 204, 210, 216, 222 in which to absorb light emanating or reflecting from particular features in the welding region 109 (FIG. 1), e.g., from the weld bead 303, welder nozzle 104, welder electrode 106, arc 107, plasma 108, weld puddle 111, work pieces 110, 112, melt zone 113, and droplet 121. Some of those features (e.g., arc 107 and plasma 108) are somewhat brighter than others (e.g., electrode 106, weld puddle 111, droplet 121, and melt zone 113) and very much brighter than still others (e.g., weld bead 103, welder nozzle 104, and work pieces 110, 112). Therefore, the intense light energy emanating or reflecting from the brightest features (e.g., from the arc 107 and plasma 108) has a higher likelihood of saturating the particular light sensors or detectors in the light sensor array of the camera 126 on which such intense light energy is focused, whereas the less intense light energy from less bright features is less likely to saturate the particular light sensors or detectors in the light sensor array of the camera 126 on which such less intense light energy is focused. Saturated light sensors or detectors do not produce usable pixel data for images. Therefore, to obtain usable pixel data from the light sensors or detectors in the light sensor array of the camera 126 on which the most intense light energy is focused, the exposure of those light sensors or detectors to such intense light energy has to be limited. On the other hand, if light energy reflected from darker features (e.g., from the weld bead 103 and work pieces 110, 112 does not have enough energy for the light sensors or detectors in the camera 126 on which such low energy light is focused to produce usable pixel data from those darker features, those pixels in the resulting raw images will not show those darker features. Therefore, longer exposure time periods may enable enough light energy from those darker features to be detected by the light sensors or detectors in the light sensor array of the camera 126 on which such less intense light energy is focused, thereby enabling those light sensors or detectors to produce useful pixel data for those darker features. Therefore, a goal of the progressively longer exposure time periods 204, 210, 216, 222 in the FIG. 2 example is to enable the particular light sensors or detectors in the light sensor array of the camera 126 on which the most intense light energy from the brightest features is focused to produce usable pixel data without saturating during the shorter exposure periods (e.g., during the first and second exposure time periods 204, 210) even if the light sensors or detectors on which the less intense light energy is focused cannot produce usable pixel data during those shorter exposure periods. Then, during the subsequent, longer exposure periods (e.g., during the third and fourth exposure time periods 216, 222), the light sensors or detectors in the light sensor array of the camera 126 on which the less intense light energy from the darker features is focused may be able to produce usable pixel data, even though the light sensors or detectors on which the most intense light energy is focused may be saturated. Accordingly, if parameters (e.g., aperture, sensor sensitivity, and optional attenuation with the optional darkening plate 130 (FIG. 1) the first raw image 204′ from the shortest exposure time period 204 in the FIG. 2 example will have usable pixels from the brightest features (e.g., the arc 107 and plasma 108), whereas each successive subsequent raw image 210′, 216′, 222′ in the FIG. 2 example may have more pixels from saturated light sensors or detectors, thus useless, but also more usable pixels from light sensors or detectors for the darker features (e.g., the weld bead 103 and work pieces 110, 112. The mid-intensity light energy from the somewhat bright features (e.g., the nozzle 104, electrode 106, puddle 111, melt zone 113, and droplet 121) may be in a range that enables the light sensors or detectors in the light sensor array of the camera 126 on which such mid-intensity light energy is focused to produce useful pixels in some or all of the raw images 204′, 210′, 216′, 222′.

The purpose of the image combiner 900 in FIG. 9 is to select and amalgamate appropriate pixels from the raw images 204′, 210′, 216′, 222′ of the FIG. 2 example techniques 200 to produce the composite image 253 with pixels that show clearly one, some, or all of the features in the welding region 109 (FIG. 1) as desired by the user for a particular view, analysis, or control purpose. Of course, that purpose is applicable to the other example techniques and raw images described herein. In one example application of the combiner 900, arbitrary pixel values 980, 981, 982, 983 from respective arbitrary corresponding pixels in the raw images 204′, 210′, 216′, 222′ are shown graphically in FIG. 9A as they occur in the first, second, third, and fourth image pixel streams 902, 904, 906, 908 in FIG. 9. Higher pixel values in the graph mean brighter, but no particular units of brightness light energy intensities are used for this illustration. In this FIG. 9A example, the saturations values 910, 912, 914, 916 for all four of the saturation comparators 926, 928, 930, 932 in FIG. 9 are set the same as each other, although they could be different. Similarly, the dark values 918, 920, 922, 924 for all four of the dark comparators 934, 936, 938, 940 in FIG. 9 are set the same as each other in this FIG. 9A example, although they could be different. Since first raw image 204′ has the shortest exposure time period (FIG. 2), the pixel value 980 of the pixel in that raw image 204′ is likely to be lower than the progressively higher pixel values 981, 982, 983 of the corresponding pixel in the second, third, and fourth raw images 210′, 216′, 222′ as explained above.

When those pixel values 980, 981, 982, 983 from the raw images 204′, 210′, 216′, 222′ are compared to the saturation value 910, 912, 914, 916 in the FIG. 9 saturation comparators 926, 928, 930, 932, the resulting saturation difference signals 942, 944, 946, 948 are progressively smaller as illustrated in FIG. 9A. In this example, the pixel value 983 from the fourth raw image 222′ is illustrated as saturated because of the long exposure time period 222 (FIG. 2) during which that fourth raw image 222′ was created, which may occur if high intensity light energy from a very bright feature in the welding region 109 (e.g., arc 107 or plasma 108) was focused on the light sensor or detector in the light sensor array of the camera 126 that created that pixel. Therefore, as illustrated in FIG. 9A, the resulting saturation difference signal 948 for that pixel value 983 in the fourth raw image 222′ is zero, which indicates that pixel in the fourth raw image 222′ is not useable. On the other hand, the non-zero saturation difference signals 942, 944, 946 resulting from the pixel values 980, 981, 982 for the corresponding pixels in the first, second, and third raw images 204′, 210′, 216′, respectively, indicate that any of those three pixel values 980, 981, 982 is potentially usable for the composite image 253 (FIG. 2), depending on what brightness, contrast, or other image characteristics are desired for the resulting composite image 253.

With continuing reference to FIG. 9A, when those pixel values 980, 981, 982, 983 from the raw images 204′, 210′, 216′, 222′ are compared to the dark value 918, 920, 922, 924 in the FIG. 9 dark comparators 934, 936, 938, 940, the resulting dark difference signals 950, 952, 954, 956 are progressively smaller. In this example, the pixel value 980 from the first raw image 222′ is illustrated as dark because of the short exposure time period 204 (FIG. 2) during which that first raw image 222′ was created, which may occur if low intensity light energy from a darker feature in the welding region 109 (e.g., weld 103 or work pieces 110, 112) was focused on the light sensor or detector in the light sensor array of the camera 126 that created that pixel. Therefore, as illustrated in FIG. 9A, the resulting dark difference signal 950 for that pixel value 980 in the first raw image 204′ is zero, which indicates that pixel in the first raw image 204′ may not be usable, unless the user does not care whether the darker features in the welding region are visible or not in a particular composite image 253. For example, the user or an automated machine vision system may just be interested in the droplet 121, which is usually not one of the darkest features, in which case, that pixel value 980 might be usable. On the other hand, the non-zero dark difference signals 952, 954, 956 resulting from the pixel values 981, 982, 983 for the corresponding pixels in the second, third, and fourth raw images 210′, 216′, 222′, respectively, indicate that any of those three pixel values 981, 982, 983 is potentially usable for the composite image 253 (FIG. 2), depending on what brightness, contrast, or other image characteristics are desired for the resulting composite image 253.

However, since the corresponding pixel from the fourth raw image 222′ is unusable due to saturation as explained above, and since the corresponding pixel from the first raw image 204′ is dark as explained above, only the corresponding pixel values 981, 982 from the second and third raw images 210′, 216′ are usable in this example for showing an illuminated feature of the welding region 109 (FIG. 1) in a composite image 253. Of course, other exposure time periods over other portions (phases) of the power waveform, other light sensor array sensitivity setting, other aperture settings, other light attenuations, supplemental illumination, and other adjustments can provide different results for various pixels. It is possible that most or even all of the corresponding pixel values of the raw images can be kept below saturation and above dark by dynamically varying such parameters as exposure time periods, phases of the power waveform over which the exposures are made, sensor array sensitivity settings, aperture settings, light attenuations, supplemental illuminations, and other adjustments during the exposure time periods.

As also shown in FIG. 9, bright range values 960 are applied to the saturation difference comparator 958. Similarly, dark range values 964 are applied to the dark difference comparator 962. The saturation difference signals 942, 944, 946, 948 are also applied to the saturation difference comparator 958. The saturation difference comparator 958 compares the saturation difference signals 942-948 and, in one embodiment, selects the largest saturation difference signal which falls within the scope of the range values 960. The selected saturation cleared pixel 966 at the output of the saturation difference comparator 958, therefore, has a pixel value that is the furthest from the saturation value, but still falls within the bright range of values 960. Accordingly, the pixel that is selected from the four different pixel streams is a pixel that is not saturated, but has a pixel value that can be displayed and viewed in the composite image. In the FIG. 9A example discussed above, the bright range values 960 may be set to provide a bright range 960′ as illustrated in FIG. 9B. In this example, therefore, the pixel value 980 from the first raw image 204′ is rejected as being below the bright range 960′, and the pixel value 983 from the fourth raw image 222′ is rejected as being above the bright range 960′. As between the two pixel values 981, 982 from the respective second and third raw images 210′, 216′, the pixel from the second raw image 210′ has a saturation difference signal 944 that is larger than the saturation difference signal 946 of the pixel from the third raw image 216′. Therefore, according to the test explained above, the saturation difference comparator 958 (FIG. 9) will select the pixel from the second raw image 210′ for use in amalgamating the composite image 253 (FIG. 2), and that pixel with its pixel value 981 is output as the selected saturation cleared pixel 966 to the pixel selector 970. In other words, the selected saturation cleared pixel 966 is a pixel that is viewable in the composite image and is not too close to the saturation point. Of course, the saturation difference comparator 958 could be set with a different test. For example, instead of selecting the largest saturation difference signal which falls within the scope of the bright range values 960, the saturation difference comparator 958 could be set to select the smallest saturation difference signal which falls within the scope of the range values 960. If the upper end of the bright range values 960 is set sufficiently below the saturation value to ensure that near saturation is not a problem, then this test will pick the brightest acceptable pixel, which, in the FIG. 9B example is the pixel from the third raw image 216′.

The dark difference signals 950, 952, 954, 956 are applied to the dark difference comparator 962. The dark difference comparator 962 selects the dark difference signal that is the greatest, but still falls within the dark range values 964. In other words, it is desirable to select pixels that are not too dark to be visible in a composite image and still fall within a range of values. The selected dark cleared pixel 968 is then applied to the pixel selector 970. In the FIG. 9A example, the dark range values 964 may be set to provide a dark range 964′ as illustrated in FIG. 9C. In this example, therefore, the pixel value 980 from the first raw image 204′ is rejected as being below the dark range 964′, and the pixel value 983 from the fourth raw image 222′ is rejected as being above the dark range 964′. As between the two pixel values 981, 982 from the respective second and third raw images 210′, 216′, the pixel from the third raw image 216′ has a saturation difference signal 954 that is larger than the saturation difference signal 952 of the pixel from the second raw image 216′. Therefore, according to the test explained above, the dark difference comparator 962 (FIG. 9) will select the pixel from the third raw image 210′ for use in amalgamating the composite image 253 (FIG. 2), and that pixel with its pixel value 982 is output as the selected dark cleared pixel 968 to the pixel selector 970. In other words, the selected dark cleared pixel 968 is a pixel that is viewable in the composite image and is not too close to the dark point. Of course, the dark difference comparator 962 could be set with a different test. For example, instead of selecting the largest saturation difference signal which falls within the scope of the dark range values 964, the saturation difference comparator 962 could be set to select the smallest dark difference signal which falls within the scope of the range values 964. If the lower end of the dark range values 964 is set sufficiently above the dark value to ensure that the pixel will be visible in the composite image, then this test will pick the darkest acceptable pixel, which, in the FIG. 9B example is the pixel from the second raw image 216′.

The pixel selector 970 selects between the selected saturation cleared pixel 966 and the selected dark cleared pixel 968 for a selected preferred pixel 972. These pixels may be the same pixel, depending upon the bright range values 960 and the dark range values 964 that are used in the saturation difference comparator 958 and dark difference comparator 962 as explained above. Further, if there is either not a selected saturation cleared pixel 966 from the saturation difference comparator 958, the pixel selector 970 will select the dark cleared pixel 968 from the dark difference comparator 962. If there is not a selected dark cleared pixel 968 from the dark difference comparator 962, the pixel selector 970 will automatically select the saturation cleared pixel 966 from the saturation difference comparator 958. The selected pixel 972 is then transmitted to an image generator 974 that generates the composite image. However, if there is not a selected saturation cleared pixel 966 and there is not a selected dark cleared pixel 968, the pixel selector 970 will not transmit a selected pixel 972 to the image generator 974. If there are a number of pixels that are not present in the composite image, more acceptable pixels may be created in the raw images by adjusting parameters such as exposure time periods, phases of the power waveform over which the exposures extend, etc., or by adjusting operating parameters of the camera 126 such as sensitivity of the light sensor array, aperture, optional darkening plate, etc., as discussed above. Further, the range values 960, 964 can also be adjusted to include more selected pixels.

The pixel selector 970 can apply any of a variety of criteria to select between the saturation cleared pixel 966 and the dark cleared pixel 968 for sending a selected pixel 972 to the image generator 974. For example, the pixel selector 970 can be provided with a median pixel value and can compare the saturation cleared pixel 966 and the dark cleared pixel 968 to the median pixel value. The pixel selector 970 can select the pixel with the pixel value that deviates furthest from the median value, or it can select the pixel with the pixel value that deviates the least from the median value. The former may provide more contrast for the resulting composite image, and the latter may provide more uniformity in the resulting composite image. In some cases, it might not make much difference whether the saturation cleared pixel 966 or the dark cleared pixel is selected, so a random selection or alternatingly selecting between those two pixels may be satisfactory.

The image combiner 900 of FIG. 9 is one example of the manner in which pixels can be selected from the raw images for a combined image. Other modifications can be made. For example, the dark comparators 934, 936, 938, 940 may be eliminated, as well as the dark difference comparator 962. The bright range values 960 can be adjusted so that the dark comparators are not needed. For high speed imaging applications, the comparators may be hardware comparators so that the image can be provided in nearly real time. In addition, the comparators of the image combiner 900 may also comprise software comparators, which function as a portion of a software implemented controller 124. The selected pixels 972 are then transmitted to image generator 974, which generates a composite image for display on display 978 and/or for analysis in analyzer 976. The analyzer 976 can be implemented in the vision system controller 124 (FIG. 1), and the display 978 can be implemented as the display device 138 in FIG. 1 on which composite images 140 are displayed in either still or video format.

Another example process 1000 of amalgamating a series of raw images to create composite images, which can facilitate faster display speed and video smoothness, is illustrated in FIG. 10. In this example process 1000, instead of amalgamating the raw images in batches or sets of four (or some other convenient number) to create the composite images as is illustrated in the FIGS. 2, 3, 4, and 5 examples, the composite images 1031, 1032, 1033, 1034, 1035, 1036, 1037, 1038, 1039, . . . , N in FIG. 10 are amalgamated in a continuous serial updating process. Accordingly, a new (updated) composite image is created after production of each raw image 1004′, 1010′, 1016′, 1022′, 1006′, 1012′, 1018′, 1024′, 1008′, 1014′, 1020′, 1026′, . . . , n′ by the camera 126 (FIG. 1), instead of waiting for sets of four raw images to be produced by the camera 126 before creating the next composite image. For example, as illustrated in FIG. 10, the first composite image 1031 is created by amalgamating pixels from the first four raw images 1004′, 1010′, 1016′, 1022′. The second composite image 1032 is then created by using pixels from the fifth raw image 1006′ and dropping (i.e., not using) pixels from the first raw image 1004′, while continuing use of pixels from the second, third, and fourth raw images 1010, 1016. Similarly, when the sixth raw image 1012′ is produced by the camera 126, the third composite image 1033 is created, using pixels from the new, sixth raw image 1012′ along with pixels from the third, fourth, and fifth raw images 1016′, 1022′, and 1006′. Likewise, each of the subsequent composite images 1033, 1034, 1035, 1036, 1037, 1038, 1039, . . . , N is created with the respective newly produced raw images 1012′, 1018′, 1024′, 1008′, 1014′, 1020′, 1026′, . . . , n′ along with pixels from the immediately preceding three raw images.

Again, for convenience and comparison, the power waveform 1002 in FIG. 10 is shown as sinusoidal similar to the power waveform 200 in FIG. 2, although other AC or DC waveforms can be used. Also for convenience and comparison, the exposure time periods 1004, 1010, 1016, 1022, 1006, 1012, 1018, 1024, 1008, 1014, 1020, 1026 in FIG. 10 are the same as the exposure time periods 204, 210, 216, 222, 206, 212, 218, 224, 208, 214, 220, 226 in FIG. 2, respectively. Also, those exposure time periods in FIG. 10 have the same exposure initiating trigger points and the same exposure terminating trigger points as the exposure initiating trigger points and exposure terminating trigger points in FIG. 2, and the same techniques can be used to establish those trigger points. Therefore, for convenience and to avoid unnecessary clutter and repetition, the exposure initiating trigger points and exposure terminating trigger points are not shown in FIG. 10. Suffice it to say that the raw images 1004′, 1010′, 1016′, 1022′, 1006′, 1012′, 1018′, 1024′, 1008′, 1014′, 1020′, 1026′ in FIG. 10 can be created in the same way as any of the raw images in the FIGS. 2, 3, 4, and 5 examples.

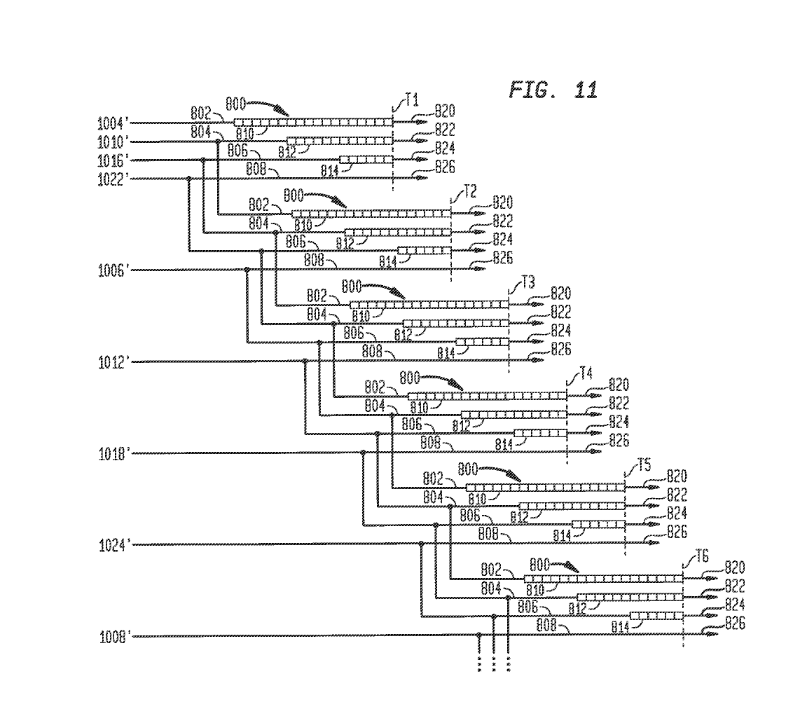

The amalgamating process shown in FIGS. 8, 9, 9A, 9B, and 9C and described above can be used to create the first composite image 1030. For example as illustrated in FIG. 11 in association with FIG. 8, the respective pixel streams of first, second, and third raw images 1004′, 1010′, 1016′ are fed into the respective first, second and third shift registers 810, 812, 814 in order to delay the first, second, and third pixel streams enough to align temporally with the pixel stream of the fourth raw image 1022′ as explained above. As a result, all four of the pixel streams of the first, second, third, and fourth raw images 1004′, 1010′, 1016′, 1022′ are output at 820, 822, 824, 826 at the same time T1 so that corresponding pixels in those four raw images 1004′, 1010′, 1016′, 1022′ reach the respective inputs 902, 904, 906, 908 of the image combiner 900 (FIG. 9) simultaneously. The image combiner 900 then selects pixels from the four pixel streams of the raw images 1004′, 1010′, 1016′, 1022′ to generate the first composite image 1031 (FIG. 10) in the image generator 974 (FIG. 9) as explained above.

As explained above, when the fifth raw image 1006′ (FIG. 10) is produced by the camera 126 (FIG. 1), the next (second) composite image 1032 in FIG. 10 is created by updating the previous composite image 1031 with new pixel data from the new raw image 1006′ and dropping the pixel data from the first raw image 1004′. Therefore, the updated (second) composite image 1031 is amalgamated from pixels selected from the second through fifth raw images 1010′, 1016′, 1022′, 1006′. With reference to FIGS. 8 and 9, such a continuous serial updating process can be done, for example, by directing the pixel streams from the immediately preceding raw images into the shift registers 810, 812, 814 of the delay hardware 800 following the pixel streams from the raw images before them. As a result, the pixel stream from the newest raw image will be temporally aligned with pixel streams of the three immediately preceding raw images. To illustrate the temporal nature of this example process, the delay hardware 800 with its three shift registers 810, 812, 814 are illustrated in FIG. 11 in symbolic sequence, although only the one delay hardware 800 is actually used. As mentioned above, the first composite image 1031 is created by feeding the pixel streams from the first four raw images 1004′, 1010′, 1016′, 1022′ into the delay hardware 800 to temporally align the respective corresponding pixels from those four raw images. The pixel streams from the first three raw images 1004′, 1010′, 1016′, 1022′ are fed into the respective shift registers 810, 812, 814 to delay those pixel streams temporally enough to align them temporally for outputting simultaneously at a time T1 to the image combiner 900 (FIG. 9). At the same time, the pixel streams of the second, third, and fourth raw images 1010′, 1016′, 1022′ are fed respectively into the first, second, and third shift registers 810, 812, 814 to delay them the proper amount of time to align temporally with the pixel stream from the new fifth raw image 1006′ when that new fifth raw image 1006′ is produced by the camera 126 (FIG. 1). Accordingly, outputs 820, 822, 824, 826 of the pixel streams of the second, third, fourth, and fifth raw images 1010′, 1016′, 1022′, 1006′ from the delay hardware 800 at the time T2 will in temporal alignment with each other. Accordingly, those temporally aligned pixel streams of the second, third, fourth, and fifth raw images 1010′, 1016′, 1022′, 1006′ are delivered to the inputs 902, 904, 906, 908 of the image combiner 900 (FIG. 9) for pixel selection and generation of the second composite image 1032 (FIG. 10) in the image generator 974 (FIG. 9) as described above.

At the same time as the pixel streams of the second, third, fourth, and fifth raw images 1010′, 1016′, 1022′, 1006′ are being aligned temporally in the delay hardware 800, the pixel streams of the third, fourth, and fifth raw images 1016′, 1022′, 1006′ are fed respectively into the first, second, and third shift registers 810, 812, 814 to delay them the proper amount of time to align temporally with the pixel stream from the new sixth raw image 1012′ when that new sixth raw image 1012′ is produced by the camera 126 (FIG. 1). Accordingly, outputs 820, 822, 824, 826 of the pixel streams of the third, fourth, fifth and sixth raw images 1016′, 1022′, 1006′, 1012′ from the delay hardware 800 at the time T3 will in temporal alignment with each other. Accordingly, those temporally aligned pixel streams of the third, fourth, fifth and sixth raw images 1016′, 1022′, 1006′, 1012′ are delivered to the inputs 902, 904, 906, 908 of the image combiner 900 (FIG. 9) for pixel selection and generation of the third composite image 1033 (FIG. 10) in the image generator 974 (FIG. 9) as described above.

At the same time as the pixel streams of the third, fourth, fifth and sixth raw images 1016′, 1022′, 1006′, 1012′ are being aligned temporally in the delay hardware 800, the pixel streams of the fourth, fifth, and sixth raw images 1022′, 1006′, 1012′ are fed respectively into the first, second, and third shift registers 810, 812, 814 to delay them the proper amount of time to align temporally with the pixel stream from the new seventh raw image 1018′ when that new seventh raw image 1018′ is produced by the camera 126 (FIG. 1). Accordingly, outputs 820, 822, 824, 826 of the pixel streams of the fourth, fifth, sixth, and seventh raw images 1022′, 1006′, 1012′, 1018′ from the delay hardware 800 at the time T4 will in temporal alignment with each other. Accordingly, those temporally aligned pixel streams of the fourth, fifth, sixth, and seventh raw images 1022′, 1006′, 1012′, 1018′ are delivered to the inputs 902, 904, 906, 908 of the image combiner 900 (FIG. 9) for pixel selection and generation of the fourth composite image 1034 (FIG. 10) in the image generator 974 (FIG. 9) as described above.

This same continuous serial updating process continues indefinitely until stopped by the user or automatically. FIG. 11 illustrates the temporal alignment process through alignment of the pixel stream of the ninth raw image 1008′ with the pixel streams of the three preceding raw images 1012′, 1018′, 1024′ for use in creating the sixth composite image 1036. As mentioned above, in this FIG. 10 example amalgamating process, a new (updated) composite image is created after production of each raw image 1004′, 1010′, 1016′, 1022′, 1006′, 1012′, 1018′, 1024′, 1008′, 1014′, 1020′, 1026′, . . . , n′ by the camera 126 (FIG. 1), instead of waiting for sets of four raw images to be produced by the camera 126 before creating the next composite image. Therefore, if the frequency of power waveform 1002 is set at the example 110 Hz as was illustrated above regarding the FIGS. 2-5 examples, composite images 1031-1039, . . . , N would be created at 110 frames per second, but each frame comprises all image information over 1/27th of a second, i.e., from four exposures. Therefore, for a power waveform of the same frequency, this FIG. 10 technique produces four times as many composite images per unit of time as the images that are created by the FIGS. 2-5 techniques.

As mentioned above, various phenomena that occur in the welding region 109 (FIG. 1) during a welding process are a function of, and can be controlled or influenced by, the power supply waveform. For example, the DC power waveform 1202 in FIG. 12A is shaped to correspond with, and to influence, the development of the droplets 121 that are melted from the distal end of the welder electrode 106. Modern welding power supplies, e.g., the welding power supply 122 in FIG. 1, can be programmed to produce DC power waveforms 136 with desired shapes and characteristics. The particular shaped power waveform 1202 in FIG. 12A has a flat phase 1205 at a base current (I) amperage level between times t₁ and t₂ that provides a base amount of electric current that sustains the arc 107 and plasma cone 108. Formation of the droplet 121 of melted electrode metal begins during this flat base phase 1205 as illustrated in the first diagrammatic example view 1281 of the welding region 109. Then, at time t₂, ramp-up phase 1207 is begun. During the ramp-up phase 1207, the amperage of the welding current is ramped up to increase heat in the electrode and to accelerate the formation of the droplet 121. Upon reaching a desired peak amperage at time t₃, the peak amperage is maintained in a peak amperage phase 1209 until a time t₃, when the amperage begins to decrease in a tail-out phase 1211. The droplet 121 develops fully during the peak amperage phase 1209 to the point of separation from the electrode 106 as illustrated in the second diagrammatic example view 1282 of the welding region 109. Then, in the tail-out phase 1211, the droplet 121 has separated from the electrode 106, as illustrated in the third diagrammatic example view of the welding region 109. The droplet 121 then falls to the weld puddle 111, where it fuses with melted metal in the melt zone 113 of the work pieces 110, 112. As the welding nozzle 104 moves on (as indicated by the arrow 105 in FIG. 1), the melted metal cools and solidifies into the weld bead 103. Therefore, providing the camera 126 (FIG. 1) with exposure initiating control signals and exposure terminating control signals that produce exposure time periods coincident with selected ones of those phases 1205, 1209, 1211 enables the welding vision and control system 100 to create composite images of those features, e.g., development stages of the droplet 121, as explained in more detail below, which are viewable in real time or storable for later viewing or analysis.

Referring now primarily to FIG. 12B, four cycles of the shaped DC power waveform 1202 are illustrated for example, and first, second, third, and fourth raw images 1204′, 1210′, 1216′, 1222′ are produced by the camera 126 (FIG. 1) with progressively increasing first, second, third, and fourth exposure time periods 1204, 1210, 1216, 1222 during each of those four cycles. Of course, in actual use, many more raw images obtained during many more cycles of the power waveform 1202 will be produced. In the FIG. 12B example, the first, second, third, and fourth raw images 1204′, 1210′, 1216′, 1222′ are produced during the respective first, second, third, and fourth exposure time periods 1204, 1210, 1216, 1222, which occur during the flat base amperage phase 1205 of the power waveform 1202. Therefore, in this FIG. 12B example, those first, second, third, and fourth exposure time periods 1204, 1210, 1216, 1222 expose the light sensors or detectors in the light sensor array 1285 of the camera 126 to light energy emanating or reflecting from the welding region 109 when the droplet 121 is just beginning to form at the distal end of the welder electrode 106 as illustrated by the first diagrammatic example view 1281 of the welding region 109 in FIG. 12A, since that phenomenon occurs during that base amperage phase 1205 of the power waveform cycle. Also, in this example, the first, second, third, and fourth exposure time periods 1204, 1210, 1216, 1222 have progressively longer durations, similar to the FIG. 2 example discussed above, so each successive raw image 1204′, 1210′, 1216′, 1222′ is produced with successively more light energy from the welding region 109. However, the exposure time periods 1204, 1210, 1216, 1222 could have the same durations as each other, as described above for the FIG. 4 example technique.

As discussed regarding the previous examples in FIGS. 2, 3, 4, 5, and 10, the detection of threshold values in the power waveform can be used to initiate the exposure time periods 1204, 1210, 1216, 1222, or, alternatively, the welding power supply 122 can provide control signals that correspond to such threshold values in the power waveform. As also explained in the FIGS. 2, 3, 4, 5, 10 examples, the vision system controller 124 (FIG. 1) or, alternatively, the welding power supply 122, can trigger the exposure time periods 1204, 1210, 1216, 1222 either immediately upon detection or occurrence of such threshold values or after a delay from such detections or occurrences. For example, the initiating threshold value for the exposure time periods 1204, 1210, 1216, 1222 can be at the initiating current threshold points 1212, 1213, 1214, 1215, where the amperage is detected to reach the base amperage level of the base amperage phase 1205 of the power waveform 1202, whereas the actual initiating trigger points 1217, 1218, 1219, 1220 for those respective exposure time periods 1204, 1210, 1216, 1222 are delayed for predetermined time periods by the vision system controller 124 (alternatively by the welding power supply 122) that are determined to provide the desired phases and exposure time periods for particular purposes or effects. The terminating trigger points 1225, 1226, 1227, 1228 are also set at respective time delays from the respective initiating current threshold points 1212, 1213, 1214, 1215 as desired for particular purposes or effects.

As illustrated diagrammatically in FIG. 12B, the shortest exposure time period 1204 provides ideal light energy exposure for light sensors or detectors in a central portion 1287 of the light sensor array 1285 by the brightest, most intense light energy emanating or reflecting from the welding region 109, e.g., from the arc 107 and plasma 108. Therefore, the raw image 1204′ produced by the light sensor array 1285 from that exposure time period 1204 has good resolution of those brightest features, e.g., the arc 107 and plasma 108. At the same time, that shortest exposure time period 1204 does not allow enough light energy from darker portions of the welding region 109 for the light sensors or detectors in the remaining outer portions 1288 to produce any raw images of features in such darker portions of the welding region 109. Therefore, the resulting raw image 1204′ produced from the exposure time period 1204 shows only the brightest features, e.g., the arc 107 and the plasma 108, and the remaining portions of the raw image 1204′ comprise dark pixels 1290.

The next, slightly longer exposure time period 1210 causes a saturated central portion 1286 of the light sensor array 1285, because the high intensity light energy emanating or reflecting from the brightest features, e.g., the arc 107 and plasma 108, saturates the light sensors or detectors of the light sensor array 1285 in that central portion 1286 in that slightly longer exposure time period 1210. At the same time, that slightly longer exposure time period 1210 provides ideal light energy exposure for light sensors or detectors in a mid-portion 1287 around the saturated central portion 1286 of the light sensor array 1285, because the light energy emanating or reflecting from the features in the mid-portion of the welding region 109, e.g., the weld puddle 111, melt zone 113, and developing droplet 121, is not bright enough to saturate the light sensors or detectors of the light sensor array 1285 on which that light energy is focused. The dimmer, outer portions of the welding region 109 do not emanate or reflect enough light energy for the light sensors or detectors in the outer portions 1288 of the light sensor array 1285 to produce any images. Therefore, the raw image 1210′ produced by the light sensor array 1285 from that slightly longer exposure time period 1210 has good resolution of those mid-brightness features, e.g., the weld puddle 111, melt zone 113, and forming droplet 121. At the same time, that slightly longer exposure time period 1210 does not allow enough light energy from darker portions of the welding region 109 for the light sensors or detectors in the remaining outer portions 1288 of the light sensor array 1285 to produce any raw images of features in such darker portions of the welding region 109. Therefore, the resulting raw image 1210′ produced from that slightly longer exposure time period 1210 shows only the fairly bright, but not the brightest, features, e.g., the weld puddle 111, melt zone 113, and forming droplet 121. The central portion pixels 1291 of the raw image 1210′ are saturated, and the remaining outer portions of the raw image 1210′ comprise only dark pixels 1290.

The next, moderately longer, exposure time period 1216 causes an even larger saturated central portion 1286 of the light sensor array 1285, because the light energy emanating or reflecting not only from the brightest features, e.g., the arc 107 and plasma 108, but also from the slightly dimmer features, e.g., the weld puddle 111, melt zone 113, and forming droplet 121, saturates the light sensors or detectors of the light sensor array 1285 in that even larger central portion 1286. At the same time, that moderately longer exposure time period 1216 provides ideal light energy exposure for light sensors or detectors in a mid-portion 1287 around the saturated central portion 1286 of the light sensor array 1285, because the light energy emanating or reflecting from the features in that mid-portion of the welding region 109, e.g., the electrode 106 and work pieces 110, 112, is in an appropriate range for the light sensors or detectors of the light sensor array 1285 on which that light energy is focused to produce image pixels of those features. The dimmer, outer portions of the welding region 109 do not emanate or reflect enough light energy for the light sensors or detectors in the outer portions 1288 of the light sensor array 1285 to produce any images. Therefore, the raw image 1216′ produced by the light sensor array 1285 from that moderately longer exposure time period 1216 has good resolution of those mid-brightness features, e.g., the electrode 106 and work pieces 110, 112. At the same time, that moderately longer exposure time period 1216 does not allow enough light energy from darker portions of the welding region 109 for the light sensors or detectors in the remaining outer portions 1288 of the light sensor array 1285 to produce any raw images of features in such darker portions of the welding region 109. Therefore, the resulting raw image 1216′ produced from that moderately longer exposure time period 1216 shows only the moderately bright features, e.g., the weld puddle 111, melt zone 113, and forming droplet 121. The central portion pixels 1291 of the raw image 1216′ are saturated, and the remaining outer portions of the raw image 1216′ comprise only dark pixels 1290.

The next, longest, exposure time period 1222 causes an even larger saturated central portion 1286 of the light sensor array 1285, because the light energy emanating or reflecting from all but the dimmest features, e.g., from the arc 107 and plasma 108, weld puddle 111, melt zone 113, forming droplet 121, electrode 106, and inner portions of the work pieces 110, 112, saturates the light sensors or detectors of the light sensor array 1285 in that even larger central portion 1286. At the same time, that longest exposure time period 1222 provides ideal light energy exposure for light sensors or detectors in an outer portion 1287 around the saturated central portion 1286 of the light sensor array 1285, because the light energy emanating or reflecting from the features in that outer portion 1287 of the welding region 109, e.g., the welding nozzle 104 and outer portions of the work pieces 110, 112, is in an appropriate range for the light sensors or detectors of the light sensor array 1285 on which that light energy is focused to produce image pixels of those features. The cooled and solidified weld bead 103, not visible in FIG. 12B, would also show in the raw image 1222′ if the camera is at an appropriate perspective to include the weld bead 103. Therefore, the raw image 1222′ produced by the light sensor array 1285 from that longest exposure time period 1222 has good resolution of those mid-brightness features, e.g., the welder nozzle 104, outer portions of the work pieces 110, 112, and weld bead 103. Therefore, the resulting raw image 1222′ produced from that longest exposure time period 1222 shows only the dimmer features, e.g., the welding nozzle 104, outer portions of the work pieces 110, 112, and weld bead 103. The central portion pixels 1291 of the raw image 1222′ are saturated.

The raw images 1204′, 1210′, 1216′, 1222′ produced by the camera 126 during the respective exposure time periods 1204, 1210, 1216, 1222, each of which has usable pixels for some, but not all, of the features in the welding region 109, are amalgamated together to create the composite image 1240. As shown in FIG. 12B and discussed above, the composite image 1240 has pixels that show all of the features in the welding region 109 with the droplet 121 starting to form at the distal end of the electrode 106, because that phenomenon occurs during the flat, base amperage phase 1205 of the power waveform 1202 as shown in FIG. 12A and discussed above, where the exposure time periods 1204, 1210, 1216, 1222 are positioned. Any of the processes discussed above for producing the composite images can be used to produce the composite image 1240 from the raw images 1204′, 1210′, 1216′, 1222′.

The example exposure time periods 1224, 1230, 1236 1242 in FIG. 12C are shown as being the same as the exposure time periods 1204, 1210, 1216, 1222 in FIG. 12B, except that the exposure time periods 1224, 1230, 1236 1242 in FIG. 12C are shifted to the peak amperage phase 1209 of the power waveform 1202, where the droplet 121 of melted metal forming at the distal end of the electrode 106 becomes fully developed to separate from the electrode 106 as shown in FIG. 12A and described above. In this FIG. 12C example, the exposure time periods 1224, 1230, 1236 1242 can be initiated by detection or other indication of the increasing current level reaching the threshold current level of the peak amperage phase 1209. Accordingly, the initiating current threshold points 1231, 1232, 1233, 1234 for the exposure time periods 1224, 1230, 1236 1242 are at the starting points of the peak amperage phase 1209, but the actual exposure time periods 1224, 1230, 1236 1242 are time-delayed from the initiating current threshold points 1231, 1232, 1233, 1234 to the respective initiating trigger points 1244, 1245, 1246, 1247. The terminating trigger points 1251, 1252, 1253, 1254 are also set at respective time delays from the respective initiating current threshold points 1231, 1232, 1233, 1234 as desired for particular purposes or effects.

As illustrated diagrammatically in FIG. 12C, the shortest exposure time period 1224 provides ideal light energy exposure for light sensors or detectors in a central portion 1287 of the light sensor array 1285 by the brightest, most intense light energy emanating or reflecting from the welding region 109, e.g., from the arc 107, plasma 108, and droplet 121. Therefore, the raw image 1224′ produced by the light sensor array 1285 from that exposure time period 1224 has good resolution of those brightest features, e.g., the arc 107, plasma 108, and droplet 121. At the same time, that shortest exposure time period 1224 does not allow enough light energy from darker portions of the welding region 109 for the light sensors or detectors in the remaining outer portions 1288 to produce any raw images of features in such darker portions of the welding region 109. Therefore, the resulting raw image 1224′ produced from the exposure time period 1224 shows only the brightest features, e.g., the arc 107, the plasma 108, and the droplet 121, and the remaining portions of the raw image 1224′ comprise dark pixels 1290.

The next, slightly longer exposure time period 1230 causes a saturated central portion 1286 of the light sensor array 1285, because the high intensity light energy emanating or reflecting from the brightest features, e.g., the arc 107, plasma 108, and droplet 121, saturates the light sensors or detectors of the light sensor array 1285 in that central portion 1286 in that slightly longer exposure time period 1230. At the same time, that slightly longer exposure time period 1230 provides ideal light energy exposure for light sensors or detectors in a mid-portion 1287 around the saturated central portion 1286 of the light sensor array 1285, because the light energy emanating or reflecting from the features in the mid-portion of the welding region 109, e.g., the weld puddle 111 and melt zone 113, is not bright enough to saturate the light sensors or detectors of the light sensor array 1285 on which that light energy is focused. The dimmer, outer portions of the welding region 109 do not emanate or reflect enough light energy for the light sensors or detectors in the outer portions 1288 of the light sensor array 1285 to produce any images in that slightly longer exposure time period 1230. Therefore, the raw image 1230′ produced by the light sensor array 1285 from that slightly longer exposure time period 1230 has good resolution of those mid-brightness features, e.g., the weld puddle 111 and melt zone 113. At the same time, that slightly longer exposure time period 1230 does not allow enough light energy from darker portions of the welding region 109 for the light sensors or detectors in the remaining outer portions 1288 of the light sensor array 1285 to produce any raw images of features in such darker portions of the welding region 109. Therefore, the resulting raw image 1230′ produced from that slightly longer exposure time period 1230 shows only the fairly bright, but not the brightest, features, e.g., the weld puddle 111 and melt zone 113. The central portion pixels 1291 of the raw image 1230′ are saturated, and the remaining outer portions of the raw image 1230′ comprise only dark pixels 1290.

The next, moderately longer, exposure time period 1236 causes an even larger saturated central portion 1286 of the light sensor array 1285, because the light energy emanating or reflecting not only from the brightest features, e.g., the arc 107, plasma 108, and droplet 121, but also from the slightly dimmer features, e.g., the weld puddle 111 and melt zone 113, saturates the light sensors or detectors of the light sensor array 1285 in that even larger central portion 1286. At the same time, that moderately longer exposure time period 1236 provides ideal light energy exposure for light sensors or detectors in a mid-portion 1287 around the saturated central portion 1286 of the light sensor array 1285, because the light energy emanating or reflecting from the features in that mid-portion of the welding region 109, e.g., the electrode 106 and work pieces 110, 112, is in an appropriate range for the light sensors or detectors of the light sensor array 1285 on which that light energy is focused to produce image pixels of those features. The dimmer, outer portions of the welding region 109 do not emanate or reflect enough light energy for the light sensors or detectors in the outer portions 1288 of the light sensor array 1285 to produce any images. Therefore, the raw image 1236′ produced by the light sensor array 1285 from that moderately longer exposure time period 1236 has good resolution of those mid-brightness features, e.g., the electrode 106 and work pieces 110, 112. At the same time, that moderately longer exposure time period 1236 does not allow enough light energy from darker portions of the welding region 109 for the light sensors or detectors in the remaining outer portions 1288 of the light sensor array 1285 to produce any raw images of features in such darker portions of the welding region 109. Therefore, the resulting raw image 1236′ produced from that moderately longer exposure time period 1236 shows only the moderately bright features, e.g., the weld puddle 111 and melt zone 113. The central portion pixels 1291 of the raw image 1236′ are saturated, and the remaining outer portions of the raw image 1236′ comprise only dark pixels 1290.

The next, longest, exposure time period 1242 causes an even larger saturated central portion 1286 of the light sensor array 1285, because the light energy emanating or reflecting from all but the dimmest features, e.g., from the arc 107, plasma 108, droplet 121, weld puddle 111, melt zone 113, electrode 106, and inner portions of the work pieces 110, 112, saturates the light sensors or detectors of the light sensor array 1285 in that even larger central portion 1286. At the same time, that longest exposure time period 1242 provides ideal light energy exposure for light sensors or detectors in an outer portion 1287 around the saturated central portion 1286 of the light sensor array 1285, because the light energy emanating or reflecting from the features in that outer portion 1287 of the welding region 109, e.g., the welding nozzle 104 and outer portions of the work pieces 110, 112, is in an appropriate range for the light sensors or detectors of the light sensor array 1285 on which that light energy is focused to produce image pixels of those features. The cooled and solidified weld bead 103, not visible in FIG. 12C, would also show in the raw image 1242′ if the camera is at an appropriate perspective to include the weld bead 103. Therefore, the raw image 1242′ produced by the light sensor array 1285 from that longest exposure time period 1242 has good resolution of those mid-brightness features, e.g., the welder nozzle 104, outer portions of the work pieces 110, 112, and weld bead 103. Therefore, the resulting raw image 1242′ produced from that longest exposure time period 1242 shows only the dimmer features, e.g., the welding nozzle 104, outer portions of the work pieces 110, 112, and weld bead 103. The central portion pixels 1291 of the raw image 1242′ are saturated.

The raw images 1224′, 1230′, 1236′, 1242′ produced by the camera 126 during the respective exposure time periods 1224, 1230, 1236 1242 are amalgamated together to create the composite image 1240. The composite image 1260 shows the droplet 121 of melted metal fully formed at the distal end of the electrode 106 to the brink of separation from the electrode 106, because that phenomenon occurs during the peak amperage phase 1209 of the power waveform 1202, as shown in FIG. 12A and explained above, which is where the exposure time periods 1224, 1230, 1236 1242 are located. Any of the processes discussed above for producing the composite images can be used to produce the composite image 1260 from the raw images 1224′, 1230′, 1236′, 1242′.

The example exposure time periods 1244, 1250, 1256, 1262 in FIG. 12D are shown as being set to coincide with the tail-out phase 1211 of the power waveform 1202 during which the droplet 121 of melted metal from the welder electrode 106 has separated from the electrode 106 and is falling to the puddle 111 as explained above. As illustrated diagrammatically in FIG. 12D, the shortest exposure time period 1244 provides ideal light energy exposure for light sensors or detectors in a central portion 1287 of the light sensor array 1285 by the brightest, most intense light energy emanating or reflecting from the welding region 109, e.g., from the arc 107, plasma 108, and droplet 121. Therefore, the raw image 1244′ produced by the light sensor array 1285 from that exposure time period 1244 has good resolution of those brightest features, e.g., the arc 107, plasma 108, and droplet 121. At the same time, that shortest exposure time period 1244 does not allow enough light energy from darker portions of the welding region 109 for the light sensors or detectors in the remaining outer portions 1288 to produce any raw images of features in such darker portions of the welding region 109. Therefore, the resulting raw image 1244′ produced from the exposure time period 1244 shows only the brightest features, e.g., the arc 107, the plasma 108, and the droplet 121, and the remaining portions of the raw image 1244′ comprise dark pixels 1290.

The next, slightly longer exposure time period 1250 causes a saturated central portion 1286 of the light sensor array 1285, because the high intensity light energy emanating or reflecting from the brightest features, e.g., the arc 107, plasma 108, and droplet 121, saturates the light sensors or detectors of the light sensor array 1285 in that central portion 1286 in that slightly longer exposure time period 1250. At the same time, that slightly longer exposure time period 1250 provides ideal light energy exposure for light sensors or detectors in a mid-portion 1287 around the saturated central portion 1286 of the light sensor array 1285, because the light energy emanating or reflecting from the features in the mid-portion of the welding region 109, e.g., the weld puddle 111 and melt zone 113, is not bright enough to saturate the light sensors or detectors of the light sensor array 1285 on which that light energy is focused. The dimmer, outer portions of the welding region 109 do not emanate or reflect enough light energy for the light sensors or detectors in the outer portions 1288 of the light sensor array 1285 to produce any images in that slightly longer exposure time period 1250. Therefore, the raw image 1250′ produced by the light sensor array 1285 from that slightly longer exposure time period 1250 has good resolution of those mid-brightness features, e.g., the weld puddle 111 and melt zone 113. At the same time, that slightly longer exposure time period 1250 does not allow enough light energy from darker portions of the welding region 109 for the light sensors or detectors in the remaining outer portions 1288 of the light sensor array 1285 to produce any raw images of features in such darker portions of the welding region 109. Therefore, the resulting raw image 1250′ produced from that slightly longer exposure time period 1250 shows only the fairly bright, but not the brightest, features, e.g., the weld puddle 111 and melt zone 113. The central portion pixels 1291 of the raw image 1250′ are saturated, and the remaining outer portions of the raw image 1250′ comprise only dark pixels 1290.

The next, moderately longer, exposure time period 1256 causes an even larger saturated central portion 1286 of the light sensor array 1285, because the light energy emanating or reflecting not only from the brightest features, e.g., the arc 107, plasma 108, and droplet 121, but also from the slightly dimmer features, e.g., the weld puddle 111 and melt zone 113, saturates the light sensors or detectors of the light sensor array 1285 in that even larger central portion 1286. At the same time, that moderately longer exposure time period 1256 provides ideal light energy exposure for light sensors or detectors in a mid-portion 1287 around the saturated central portion 1286 of the light sensor array 1285, because the light energy emanating or reflecting from the features in that mid-portion of the welding region 109, e.g., the electrode 106 and work pieces 110, 112, is in an appropriate range for the light sensors or detectors of the light sensor array 1285 on which that light energy is focused to produce image pixels of those features. The dimmer, outer portions of the welding region 109 do not emanate or reflect enough light energy for the light sensors or detectors in the outer portions 1288 of the light sensor array 1285 to produce any images. Therefore, the raw image 1256′ produced by the light sensor array 1285 from that moderately longer exposure time period 1256 has good resolution of those mid-brightness features, e.g., the electrode 106 and work pieces 110, 112. At the same time, that moderately longer exposure time period 1256 does not allow enough light energy from darker portions of the welding region 109 for the light sensors or detectors in the remaining outer portions 1288 of the light sensor array 1285 to produce any raw images of features in such darker portions of the welding region 109. Therefore, the resulting raw image 1256′ produced from that moderately longer exposure time period 1236 shows only the moderately bright features, e.g., the weld puddle 111 and melt zone 113. The central portion pixels 1291 of the raw image 1236′ are saturated, and the remaining outer portions of the raw image 1236′ comprise only dark pixels 1290.

The next, longest, exposure time period 1262 causes an even larger saturated central portion 1286 of the light sensor array 1285, because the light energy emanating or reflecting from all but the dimmest features, e.g., from the arc 107, plasma 108, droplet 121, weld puddle 111, melt zone 113, electrode 106, and inner portions of the work pieces 110, 112, saturates the light sensors or detectors of the light sensor array 1285 in that even larger central portion 1286. At the same time, that longest exposure time period 1262 provides ideal light energy exposure for light sensors or detectors in an outer portion 1287 around the saturated central portion 1286 of the light sensor array 1285, because the light energy emanating or reflecting from the features in that outer portion 1287 of the welding region 109, e.g., the welding nozzle 104 and outer portions of the work pieces 110, 112, is in an appropriate range for the light sensors or detectors of the light sensor array 1285 on which that light energy is focused to produce image pixels of those features. The cooled and solidified weld bead 103, not visible in FIG. 12D, would also show in the raw image 1262′ if the camera is at an appropriate perspective to include the weld bead 103. Therefore, the raw image 1262′ produced by the light sensor array 1285 from that longest exposure time period 1262 has good resolution of those mid-brightness features, e.g., the welder nozzle 104, outer portions of the work pieces 110, 112, and weld bead 103. Therefore, the resulting raw image 1262′ produced from that longest exposure time period 1262 shows only the dimmer features, e.g., the welding nozzle 104, outer portions of the work pieces 110, 112, and weld bead 103. The central portion pixels 1291 of the raw image 1262′ are saturated.

Detection of predetermined amperages in the tail-out phase 1211 of the power waveform 1202 can be used for the initiating current threshold points 1263, 1264, 1265, 1266 for the exposure time periods 1244, 1250, 1256 1262 with a time delay to the initiating trigger points 1267, 1268, 1269, 1270. For example, the initiating current threshold points 1263, 1264, 1265, 1266 can be where there is a detectable amperage drop from the peak amperage phase 1209 with a time delay to desired exposure initiating trigger points 1267, 1268, 1269, 1270. Alternatively, specific initiating current thresholds can be set at the specific locations on the tail-out phase 1211 of the power waveform 1202 where the exposure time periods 1244, 1250, 1256 1262 are to be initiated, in which case the trigger points 1267, 1268, 1269, 1270 would be the initiating current threshold points. The terminating trigger points 1271, 1272, 1273, 1274 are also set at respective time delays from the respective initiating current threshold points 1231, 1232, 1233, 1234 as desired for particular purposes or effects, or they could be set at a specific detectable terminating current threshold level. The raw images 1244′, 1250′, 1256′, 1262′ produced by the camera 126 during the respective exposure time periods 1244, 1250, 1256 1262 are amalgamated together to create the composite image 1280. The composite image 1280 shows the droplet 121 of melted metal separated from the distal end of the electrode 106 and falling toward the weld puddle 111, because that phenomenon occurs during the tail-out phase 1211 of the power waveform 1202, which is where the exposure time periods 1244, 1250, 1256 1262 are located. Any of the processes discussed above for producing the composite images can be used to produce the composite image 1280 from the raw images 1244′, 1250′, 1256′, 1262′. As illustrated by the examples in FIGS. 12B, 12C, and 12D, different features in the welding region 109 can be captured and displayed by positioning the exposure time period at different phases of the power waveform 1202. In the composite image 1240 (FIG. 12B), the droplet 121 is shown as just beginning to form at the distal end of the welder electrode 106, whereas the composite image 1260 (FIG. 12C) shows the droplet 121 fully formed and at the brink of separating from the electrode 106, and the composite image 1280 shows the droplet 121 separated from the electrode 106 and in mid-fall toward the weld puddle 111. These and many other different phenomena in a welding process can be captured with the camera 126 by shifting the exposure time periods to align with different phases of the power waveform. When a series of composite images produced from exposure time periods in a particular phase of the power waveform 1202 during a welding operation are viewed in a continuous series, for example in rapid succession as successive frames in a video, e.g., 24 to 30 composite images per second, those phenomena that occur in that particular phase can be viewed in the display device in real time. In other words, the composite image displayed on the display device 138 may appear to be one image, but it is actually a continuous sequence of composite images displaying in rapid succession, e.g., 24 to 30 images per second, which the human eye and brain sees as one image. Shifting the exposure time periods to a different phase of the power waveform 1202 can enable the user to view other features and phenomena of the welding process in real time. Such phase shifts of the exposure time periods can be in increments, or they can be done in a continuous sweep across the power waveform phases. For example, a slow dynamic shift of the exposure time periods 1244, 1250, 1256, 1262 in FIG. 12D over all of the phases in an entire cycle of the power waveform 1202, i.e., from the flat base phase 1205 through the ramp-up phase 1207, across the peak amperage phase 1209, and down the tail-out phase 1211 to the flat base amperage phase 1205 may produce a video of the droplet 121 beginning to form at the distal end of the electrode 106 and continuing to develop to a fully formed droplet 121 separating from the electrode 106 and falling to the puddle 111. On the other hand, the exposure time periods 1244, 1250, 1256, 1262 could be adjusted, even while viewing the composite images as a video, to a static location in the tail-out phase 1211 that results in the composite image showing the droplet 121 just as it reaches the weld puddle 111. Then, fixing that location for the exposure time periods 1244, 1250, 1256, 1262 could enable a welder, for examine a person doing manual welding, to watch a real time video of the weld as he or she holds the tip and electrode of the welder exactly where the video shows the droplet 121 meeting the puddle 111.

The embodiments of the present invention therefore provide systems and methods for viewing the welding process and generating combined images that have a high visual dynamic range. These techniques can be used in automated welding systems, such as the automated welding vision and control system 100 illustrated in FIG. 1 and in manual systems, such as the manual welding vision system 1300 illustrated in FIG. 13 and described below. The high visual dynamic range of the system allows various portions of the weld to be viewed during the welding process, as well as the background. The composite images, therefore, provide a large amount of information relating to the quality of the weld, which allows for adjustment of parameters to achieve high quality welds.

As mentioned above, the optional dynamic darkening plate 130 shown in FIG. 1 can be used to further control the light intensities emanating from the arc 107, plasma 108, weld droplets 121, weld puddle 111, and other features in the welding region 109 that are incident on the light detector elements of the camera 126. The optional dynamic darkening plate 130 can be controlled by the vision system controller 124 to attenuate light energy that emanates or reflects from the welding region 109 or features in the welding region 109. As such, the optional dynamic darkening plate 130 further controls the exposure of the camera 126 to either assist the aperture of the camera 126 and sensitivity of the light detector elements of the camera 126, or may be used alone, without adjusting the aperture size or the sensitivity of the light detector elements of camera 126. Further, the optional dynamic darkening plate 130 can be operated in such a manner that it is activated for only a short time during the initial flash of the arc 107 that occurs at the peak of the power pulse and for a short time after the peak. The example dynamic darkening plate 130 in the example welding and vision control system 100 can be made, for example, with polymer dispersed liquid crystal (PDLC) film materials, which are available commercially and have variable light transmissivity the responds very quickly to variations in applied voltage. Liquid crystal darkening filters for cameras, which can also provide the function of the darkening plate 130 are available commercially, e.g., LC-Tech Displays AB, of Borlänge, Sweden. In this manner, the controller 124 can easily control the dynamic darkening plate 130 by the application of a control voltage signal. For example, a darkening plate control signal produced as a negative of the power waveform from the welding power supply 122 can be applied to the plate 130 to condition incoming light to the camera 126 to produce uniform light intensity. Other variations on the darkening plate control signal are possible. The vision system controller 124 is programmed to synchronize the initiating and terminating trigger control signals to the camera 126 and darkening plate control signals with the raw image output of the camera 126. Alternatively, the exposure time periods for each raw image could be held constant for some or all of the raw images used to create a composite image while either the light transmissivity of darkening plate 130 or the light sensitivity of the light sensor array in the camera 126, or a combination of both, is progressively increased or decreased for successive raw images in order to enhance the likelihood that all of the features in the welding region 109 are captured effectively in at least one or more of the raw images. The user interface 128 is also connected to the vision system controller 124, so the user interface 128 can be used to vary the transmissivity of the dynamic darkening plate 130 as well as other operating parameters of the welding/vision and control system 100 illustrated in FIG. 1. The optional camera 127 can also be provided with a dynamic darkening plate 131 and used in the same manner as described above for the camera 126.

FIG. 1 also illustrates an optional optical detector 132. The optional optical detector 132 can be used to detect the initial flash of each welding pulse to initiate the processes illustrated in FIGS. 2-5. The optional optical detector 132 is coupled to the vision system controller 124 to signal the vision system controller 124 that a welding pulse has been detected at that instant. Precise timing of the exposures can then also optionally be triggered from the signal generated by the optical detector 132. The optional optical detector 132 can also create the trigger event in the image process controller 124.

An example manual welding vision system 1300, which can be equipped with some or all of the features and capabilities described above, including, but not limited to, the features and capabilities in the FIG. 1, is illustrated diagrammatically in FIG. 13. A human welder 1318 is illustrated as wearing a helmet 1302 which has a display 1304 on the inside of the helmet 1302. The display 1304 operates in response to the cameras 1306 and electronics package 1308 as described above in regard to the cameras 126, 127 and vision system controller 124 in FIG. 1. The human welder 1318 uses a manual arc welder 1310 to produce a weld bead 1312 at the intersection of the work pieces 1314, 1316. The manual arc welder 1310 is controlled by the human welder 1318, who observes the welding process in the welding region 1209 on the display 1304 in real time. The two cameras 1306, which can optionally be equipped with darkening plates such as the darkening plates 130, 131 in FIG. 1, generate simultaneous raw images of the welding region 1209 or features in the welding region 1209 from the two different perspectives of the cameras 1306 for creation of two composite images for stereoscopic viewing, although only one camera could be used for monoscopic viewing. The raw images from the two cameras 1306 are processed by the electronics package 1308 as explained above to create two respective composite images from the two perspectives, and the two composite images are displayed simultaneously in the display 1304, e.g., one composite image from one perspective for display to one of the human's eyes and the second composite image from the second perspective for display to the human's other eye, which creates or enhances the illusion of 3D depth. Of course, a monoscopic display would present the one composite image from one camera to both eyes. The composite images, whether stereoscopic or monoscopic, allow the human welder 1318 to view features in the welding region that emanate or reflect high intensity light energy (e.g., the arc, plasma, etc.) as well as features that emanate or reflect less bright features (e.g., molten droplets and puddles) and somewhat darker features (e.g., the weld bead, work pieces that are being joined by the weld, etc.) in real time as the welding procedure is performed. In that manner, the human welder 1318 can view the environment and background, as well as viewing the plasma, the droplets from the manual arc welder 1310, the puddles, and other important portions or features of the developing weld 1312 in real time during the welding process. In this manner, the helmet 1302 does not need a partially transmissive glass window, since the human welder 1318 simply views the display 1304 on the inside of the helmet 1302 and can see the entire process with high visual dynamic range, which is not possible to see with a typical welder's helmet looking through only darkened glass.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. The words “comprise,” “comprises,” “comprising,” “include,” “including,” and “includes” when used in this specification, including the features, are intended to specify the presence of stated features, integers, components, or steps, but they do not preclude the presence or addition of one or more other features, integers, components, steps, or groups thereof. It is intended that the appended claims be construed to include other alternative embodiments of the invention except insofar as limited by the prior art.

The invention and several embodiments in which an exclusive property or privilege is claimed are defined as follows:

1. A welding vision and control system for an arc welding system in which the arc welding system is powered by a cyclical power waveform from a welding power supply to produce a weld bead on a work piece in a welding region, comprising:
a camera that has a light sensor array focused on the welding region or on a feature in the welding region, said camera being responsive to exposure initiating control signals to expose the light sensor array to light energy emanating or reflecting from the welding region or from a feature in the welding region to produce a series of raw images of the welding region or the feature in the welding region; and
a vision system controller that generates the exposure initiating control signals to the camera at a predetermined trigger point on a cyclical power waveform.

2. The welding vision and control system of claim 1, including an electrical characteristic sensor that senses an electrical characteristic (V, I) in the cyclical power waveform, and wherein the vision system controller senses an exposure initiating threshold value in the cyclical power waveform and, in response, generates the exposure initiating control signals to the camera.

3. The welding and control system of claim 1, wherein the welding power supply generates the exposure initiating control signals to the camera in synchronization with a predetermined trigger point on the cyclical power waveform.

4. The welding vision and control system of claim 2, wherein the camera exposes the light sensor array to the to light energy emanating or reflecting from the welding region or from a feature in the welding region for an exposure time period at a phase of the cyclical power waveform.

5. The welding vision and control system of claim 4, wherein the vision system controller generates the exposure initiating control signals to the camera at predetermined time delays after sensing when the electrical characteristic (V, I) in the cyclical power waveform matches the exposure initiating threshold value.

6. The welding vision and control system of claim 2, wherein the camera is responsive to exposure terminating control signals to terminate exposure time periods during which the light sensor array is exposed to the light energy emanating or reflecting from the welding region or from a feature in the welding region.

7. The welding vision and control system of claim 6, wherein the vision system controller generates the exposure terminating control signals to the camera at predetermined time delays after sensing when the electrical characteristic in the cyclical power waveform matches the exposure initiating threshold value.

8. The welding vision and control system of claim 6, wherein the vision system controller senses when the electrical characteristic in the cyclical power waveform matches exposure terminating threshold values and, in response, generates the exposure terminating control signals to the camera.

9. The welding vision and control system of claim 2, wherein the light sensor array comprises individual light sensors, each of which is exposed to a discrete portion of the light energy emanating and reflecting from the welding regions or from the feature in the welding region during an exposure time period, and wherein the camera exposes the light sensor array to the to light energy emanating or reflecting from the welding region or from a feature in the welding region in a sequence of the exposure time periods to produce each of the respective raw images in the series of raw images in a pixel array format in which each pixel in the pixel array format has a pixel value that is indicative of the light energy that is absorbed by one of the light sensors in the light sensor array during a respective one of the exposure time periods.

10. The welding vision and control system of claim 9, wherein the vision system controller amalgamates a first plurality of the raw images into a first composite image by performing logical operations that select pixels from the plurality of raw images that have non-saturated pixel values and non-dark pixel values and that amalgamate selected pixels into the first composite image.

11. The welding vision and control system of claim 10, wherein the vision system controller amalgamates a second and subsequent pluralities of the raw images into a second and subsequent composite images by performing logical operations that select pixels from the second and subsequent pluralities of raw images that have non-saturated pixel values and non-dark pixel values and that amalgamate selected pixels into the second and subsequent composite images.

12. The welding vision and control system of claim 11, wherein the vision system controller streams the first, second, and subsequent composite images in series to a display device for video display on the display device.

13. The welding vision and control system of claim 12, including a user interface connected to the vision system controller for inputting vision control parameters to the vision system controller.

14. The welding vision and control system of claim 13, wherein the vision system controller is programmed to receive inputs from the user interface for changing the phase of the cyclic power waveform at which the exposure time period occurs and, in response, to change the exposure initiating threshold value or the time delay after detection of the exposure initiating threshold value in the cyclic power waveform for generating the exposure initiating control signal or the exposure terminating control signal to the camera.

15. The welding vision and control system of claim 11, wherein the vision system controller performs logical operations that apply pattern recognition or analysis to the second and subsequent composite images to identify a deviation from a pre-set parameter of one or more of the features in the welding region and in response to identification of the deviation, outputs one or more signals to the welding power supply to modify a parameter of the cyclic power waveform in a manner that corrects the deviation.

16. The welding vision and control system of claim 11, wherein the vision system controller performs logical operations that apply pattern recognition or analysis to the second and subsequent composite images to identify a deviation from a pre-set parameter of one or more of the features in the welding region and in response to identification of the deviation, outputs one or more signals to the robot system controller to modify a physical parameter of the arc welder system in a manner that corrects the defect.

17. The welding vision and control system of claim 11, wherein the vision system controller performs logical operations that apply pattern recognition or analysis to the second and subsequent composite images to identify a deviation from a pre-set parameter of one or more of the features in the welding region and, in response to identification of the deviation, outputs one or more alarm or notice signals to the display device or an alarm or notice system that identifies the deviation.

18. The welding vision and control system of claim 2, wherein the camera includes a darkening plate that dynamically adjustable light transmissivity in response to a transmissivity control signal.

19. The welding vision and control system of claim 18, wherein the vision system controller generates the transmissivity control signal to the camera darkening plate.

20. The welding vision and control system of claim 19, wherein the vision system controller generates the transmissivity control signal as a negative of the cyclical power waveform.

21. The welding vision and control system of claim 2, wherein the light sensor array has adjustable sensitivity to light energy that is controllable by a sensitivity control signal generated by the vision system controller.

22. The welding vision and control system of claim 2, wherein the camera has an adjustable aperture that is controllable by an aperture control signal generated by the vision system controller.

23. A method of creating a series of raw images of a welding region or of a feature in the welding region during a welding process that is powered by a cyclical power waveform in which an electrical characteristic (V, I) varies cyclically, comprising:
focusing a camera on the welding region or on the feature in the welding region; and
triggering the camera to expose a light sensor array in the camera to light energy emanating or reflecting from the welding region or the feature in the welding region for a sequence of exposure time periods to create the raw images of the welding region or the feature in the welding region at predetermined phases of the cyclical power waveform.

24. The method of claim 23, including triggering the camera to expose the light sensor array in the camera to the light energy emanating or reflecting from the welding region or the feature in the welding region for the sequence of exposure time periods to create the raw images of the welding region or the feature in the welding region at the predetermined phases of the cyclical power waveform in response to detection of a predetermined exposure initiating threshold value of the electrical characteristic in the cyclical power waveform.

25. The method of claim 23, including triggering the camera to expose the light sensor array in the camera to the light energy emanating or reflecting from the welding region or the feature in the welding region at predetermined time delays after the detection of the exposure initiating threshold value of the electrical characteristic in the cyclical power waveform.

26. The method of claim 23, including providing different initiating threshold values for some of the exposure time periods to initiate the exposures of the light sensor array in the camera to the light energy emanating or reflecting from the welding region or the feature in the welding region at the different phases of the cyclical welding power waveform.

27. The method of claim 23, including providing some of the exposure time periods with different durations than others of the exposure time periods to expose the light sensor array to the light energy emanating or reflecting from the welding region or the feature in the welding region for different phases of the cyclical power waveform.

28. The method of claim 23, including triggering the camera to terminate the image exposure periods at predetermined time delays after the detection of the exposure initiating threshold value of the electrical characteristic in the cyclical power waveform.

29. The method of claim 23, including triggering the camera to terminate the image exposure time periods in response to detection of predetermined exposure terminating threshold values of the electrical characteristic in the cyclical power waveform for the respective image exposure time periods.

30. A method of creating a raw image of a welding region or of a feature in the welding region during a welding process that is powered by a cyclical power waveform in which an electrical characteristic (V, I) varies cyclically, comprising:
focusing a camera on the welding region or on the feature in the welding region, wherein the camera is responsive to an exposure initiating control signal for initiating exposure of a light sensor array in the camera to light energy emanating or reflecting from the welding region or the feature in the welding region for an exposure time period to create the raw image of the welding region or the feature in the welding region;
detecting an exposure initiating threshold value of the electrical characteristic in the cyclical power waveform; and
generating the exposure initiating control signal in response to the detection of the exposure initiating threshold value of the electrical characteristic in the cyclical power waveform.

31. The method of claim 30, including generating the exposure initiating the control signal at a predetermined time delay after the detection of the initiating threshold value in the cyclical power waveform.

32. The method of claim 30, wherein the camera is responsive to an exposure terminating control signal to terminate the exposure of a light sensor array in the camera to light energy emanating or reflecting from the welding region or the feature in the welding region.

33. The method of claim 32, including detecting an exposure terminating threshold value of the electrical characteristic in the welding power waveform, and generating the exposure terminating signal to the camera in response to the detection of the exposure terminating threshold value in the cyclical power waveform to terminate the exposure of the light sensor array in the camera to light energy emanating or reflecting from the welding region or the feature in the welding region.

34. The method of claim 32, including generating the exposure terminating control signal at a predetermined time delay after the detection of the exposure initiating threshold value of the electrical characteristic in the cyclical power waveform.

35. A method of viewing a particular feature in a welding region (109) during a welding process which is powered by a cyclical power waveform in which an electrical characteristic (V, I) varies cyclically, comprising:
focusing a camera on the welding region, wherein the camera is responsive to exposure initiating control signals for initiating exposures of a light sensor array in the camera to light energy emanating or reflecting from the feature in the welding region for a sequence of exposure time periods;
generating the exposure initiating control signals to expose the light sensor array to light energy emanating or reflecting from the welding region during the time periods at a first phase of the cyclical power waveform to produce a series of composite images from the sequence of exposure time periods;
streaming the series of composite images of the feature to a display device for video display of features in the welding region as the features exist during the first phase of the cyclical power waveform; and
changing the exposure time periods to occur at different phases of the cyclical power waveform until the exposure time periods occur at a phase in which the particular feature exists so that the particular feature is shown in the series of composite images in the video display.

36. A method of generating a video of a welding process from a series of composite images produced by a camera comprising:
applying a plurality of operating parameters for a first mode of operation of a video camera to generate a plurality of sets of single images of said welding process;
using a waveform, created by an arc welder that performs said welding process, to synchronize said plurality of sets of single images with said welding process by:
providing first trigger pulses at a first set of locations on said waveform, responsive to said operating parameters, that are used to open a shutter of said camera so that each of said single images in any given set of said sets of single images has a corresponding image in other sets of said single images that is triggered at substantially the same location on said waveforms;
producing second trigger pulses at a second set of locations on said waveform, responsive to said operating parameters, that are used to close said shutter on said camera, so that each of said single images in any given set of said sets of single images has a corresponding image in other sets of said single images that has substantially the same exposure period;
creating said series of combined images from said plurality of sets of single images by combining said single images in said sets of single images to produce said combined images;
generating said video of said welding process from said series of combined images;
analyzing said video of said welding process to provide an analysis of said welding process; and
modifying said welding process in response to said analysis.

37. The method of claim 36 wherein said process of producing first trigger pulses comprises producing first trigger pulses that occur at substantially the same location on said waveform for all of said single images.

38. The method of claim 36 wherein said process of producing first trigger pulses comprises producing first trigger pulses that occur at different locations on said waveform within each of said sets of single images.

39. The method of claim 37 wherein said process of producing second trigger pulses comprises producing second trigger pulses that occur at substantially the same location on said waveform for all said single images.

40. The method of claim 38 wherein said process of producing second trigger pulses comprises producing second trigger pulses that occur at substantially the same location on said waveform for all said single images.

41. The method of claim 37 wherein said process of producing second trigger pulses comprises producing second trigger pulses that occur at different locations on said waveform within each of said sets of single images.

42. The method of claim 38 wherein said process of producing second trigger pulses comprises producing second trigger pulses that occur at different locations on said waveform within each of said sets of single images.

43. The method of claim 36 further comprising displaying said video.

44. The method of claim 36 further comprising illuminating background areas surrounding said welding process with lights so that said background area appears in said video.

45. The method of claim 36 wherein said process of producing first trigger pulses comprises setting threshold values and detecting when said waveform reaches said threshold values.

46. The method of claim 45 wherein said process of producing second trigger pulses comprises setting threshold values and detecting when said waveform reaches said threshold values.

47. The method of claim 45 wherein said process of producing second trigger pulses comprises using delay periods that run from said first trigger pulses.

48. The method of claim 36 further comprising applying a plurality of operating parameters for a second mode of operation of said video camera.

49. A system for generating a video of a welding process comprising:
a wire feed welder that welds metal welding pieces to produce a weld;
a welding power supply that produces a power supply waveform that is applied to said welder;
a camera, having a shutter, that is aligned to generate a plurality of sets of single images of said welding process in response;
a controller that senses said power supply waveform and generates first trigger pulses at a first set of locations on said waveform that are used to open said shutter on said camera so that each of said single images in any given set of said plurality of sets of single images has corresponding images in said plurality of sets of single images that are triggered at substantially a same location on said waveform, and generates second trigger pulses at a second set of locations on said waveform that are used to close said shutter on said camera so that each of said single images in any given set of said plurality of sets of single images has corresponding images in said plurality of sets of single images that have substantially equal exposure periods that start at said substantially same location on said waveform, said controller performing logical operations to combine single images in each set of single images to produce combined images that are suitable for display and analysis.

50. The system of claim 49 wherein said controller generates said first trigger pulses such that said first set of locations on said waveform in each set of single images is substantially the same.

51. The system of claim 49 wherein said controller generates said first trigger pulses, such that at least some of said first set of locations on said waveform in each set of single images is different.

52. The system of claim 50 wherein said controller generates said second trigger pulses, such that said second set of locations on said waveform in each set of single images is substantially the same.

53. The system of claim 50 wherein the controller generates said second trigger pulses, such that at least some of said second set of locations on said waveform in each set of single images are different.

54. The system of claim 51 wherein the controller generates said second trigger pulses, such that at least some of said second set of locations on said waveform in each set of single images are different.

55. The system of claim 49 further comprising a display for displaying said combined images.

56. The system of claim 49 further comprising lights that illuminate welding pieces so that said welding pieces are visible in said combined images.

57. The system of claim 49 wherein said controller senses said power supply waveform and generates said first trigger pulses by comparing a threshold value to said power supply waveform.

58. The system of claim 49 further comprising a plurality of shift registers that temporally align pixels from a plurality of pixel streams for each image in each set of said plurality of sets of single images.

59. The system of claim 49 wherein said controller comprises a plurality of comparators that select pixels for said combined image based upon an illumination value of said pixels.
